(19) United States
(12) Patent Application Publication
(10) Pub. No.: US 2017/0231014 A1
(43) Pub. Date: Aug. 10, 2017

(54) SYSTEM FOR INTER-COMMUNICATION BETWEEN LAND MOBILE RADIO AND PUSH-TO-TALK-OVER-CELLULAR SYSTEMS

(71) Applicant: Kodiak Networks Inc., Plano, TX (US)

(72) Inventors: Krishnakant M. Patel, Richardson, TX (US); Ramu Kandula, Plano, TX (US); Brahmananda R. Vempati, Dallas, TX (US); Pravat Kumar Singh, Bangalore (IN); Harisha M. Negalaguli, Richardson, TX (US); Bibhudatta Biswal, Richardson, TX (US); Basem Ahmad Ardah, Plano, TX (US)

(21) Appl. No.: 15/494,340

(22) Filed: Apr. 21, 2017

Related U.S. Application Data
(63) Continuation of application No. PCT/US2015/056712, filed on Oct. 21, 2015.
(60) Provisional application No. 62/066,533, filed on Oct. 21, 2014.

(51) Int. Cl. H04W 76/00; H04W 8/26; H04L 29/06; H04W 4/10

(52) U.S. Cl. CPC H04W 76/005; H04W 4/10; H04W 8/26; H04L 65/608; H04W 88/16

(57) ABSTRACT

A network-to-network interface (NNI) gateway for inter-communication between a Push-to-Talk-over-Cellular (PoC) system in a first wireless network and a Land Mobile Radio (LMR) system in a second wireless network. The PoC system performs a PoC call session for PoC mobile units in the first wireless network. The LMR system performs a Push-to-Talk (PTT) call session for LMR subscriber units in the second wireless network. Both the PoC and PIT call sessions comprise an instant two-way half-duplex voice call within a group of the PoC mobile units and/or LMR subscriber units. The gateway bridges the LMR system to the PoC system, such that the PoC system is exposed to the LMR system as an emulated LMR system, the LMR system is exposed to the PoC system as an emulated PoC system, and calls are placed across the first and second wireless networks between the PoC mobile units and LMR subscriber units.

### CROSS-REFERENCE TO RELATED APPLICATIONS

This application is a continuation of International Application Serial No. PCT/US2015/056712, filed Oct. 21, 2015, which claims the benefit of U.S. Provisional Application No. 62/066,533, filed on Oct. 21, 2014, which applications are hereby incorporated herein by reference.

This application is related to the following commonly-assigned patent applications:

U.S. Utility application Ser. No. 10/515,556, filed Nov. 23, 2004, by Gorachand Kundu, Ravi Ayyasamy and Krishnakant Patel, entitled “DISPATCH SERVICE ARCHITECTURE FRAMEWORK,”, now U.S. Pat. No. 7,787,896, issued Aug. 31, 2010, which application claims the benefit under 35 U.S.C. Section 365 of P.C.T. International application Serial Number PCT/US03/16386, which application claims the benefit under 35 U.S.C. Section 119(e) of U.S. Provisional Application Ser. Nos. 60/382,981, 60/383,179 and 60/407,168;

U.S. Utility application Ser. No. 10/564,903, filed Jan. 17, 2006, by F. Craig Farrill, Bruce D. Lawler and Krishnakant M. Patel, entitled “PREMIUM VOICE SERVICES FOR WIRELESS COMMUNICATIONS SYSTEMS,” which application claims the benefit under 35 U.S.C. Section 365 of P.C.T. International Application Serial Number PCT/US04/23038, which application claims the benefit under 35 U.S.C. Section 119(e) of U.S. Provisional Application Ser. Nos. 60/488,638, 60/492,650 and 60/576,094 and which application is a continuation-in-part and claims the benefit under 35 U.S.C. Sections 119, 120 and/or 365 of P.C.T. International Application Serial Number PCT/US03/16386;

U.S. Utility application Ser. No. 11/126,587, filed May 11, 2005, by Ravi Ayyasamy and Krishnakant M. Patel, entitled “ARCHITECTURE, CLIENT SPECIFICATION AND APPLICATION PROGRAMMING INTERFACE (API) FOR SUPPORTING ADVANCED VOICE SERVICES (AVS) INCLUDING PUSH TO TALK ON WIRELESS HANDSETS AND NETWORKS,” now U.S. Pat. No. 7,738,892, issued Jun. 15, 2010, which application claims the benefit under 35 U.S.C. Section 119(e) of U.S. Provisional Application Ser. Nos. 60/569,953 and 60/579,309, and which application is a continuation-in-part and claims the benefit under 35 U.S.C. Sections 119, 120 and/or 365 of U.S. Utility application Ser. No. 10/515,556 and P.C.T. International Application Serial Number PCT/US04/23038;

U.S. Utility application Ser. No. 11/129,268, filed May 13, 2005, by Krishnakant M. Patel, Gorachand Kundu, Ravi Ayyasamy and Basem Ardah, entitled “ROAMING GATEWAY FOR SUPPORT OF ADVANCED VOICE SERVICES WHILE ROAMING IN WIRELESS COMMUNICATIONS SYSTEMS,” now U.S. Pat. No. 7,403,775, issued Jul. 22, 2008, which application claims the benefit under 35 U.S.C. Section 119(e) of U.S. Provisional Application Ser. No. 60/571,075, and which application is a continuation-in-part and claims the benefit under 35 U.S.C. Sections 119, 120 and/or 365 of U.S. Utility application Ser. No. 10/515,556 and P.C.T. International Application Serial Number PCT/US04/23038;

U.S. Utility application Ser. No. 11/134,883, filed May 23, 2005, by Krishnakant Patel, Vyankatesh V. Shanbhag, Ravi Ayyasamy, Stephen R. Horton and Shan-Jen Chiou, entitled “ADVANCED VOICE SERVICES ARCHITECTURE FRAMEWORK,” now U.S. Pat. No. 7,764,950, issued Jul. 27, 2010, which application claims the benefit under 35 U.S.C. Section 119(e) of U.S. Provisional Application Ser. Nos. 60/573,059 and 60/576,092, and which application is a continuation-in-part and claims the benefit under 35 U.S.C. Sections 119, 120 and/or 365 of U.S. Utility application Ser. No. 10/515,556, P.C.T. International Application Serial Number PCT/US04/23038, U.S. Utility application Ser. No. 11/126,587, and U.S. Utility application Ser. No. 11/129,268;

U.S. Utility application Ser. No. 11/136,233, filed May 24, 2005, by Krishnakant M. Patel, Vyankatesh Vasant Shanbhag, and Anand Narayanan, entitled “SUBSCRIBER IDENTITY MODULE (SIM) ENABLING ADVANCED VOICE SERVICES (AVS) INCLUDING PUSH-TO-TALK, PUSH-TO-CONFERENCE AND PUSH-TO-MESSAGE ON WIRELESS HANDSETS AND NETWORKS,” now U.S. Pat. No. 7,738,896, issued Jun. 15, 2010, which application claims the benefit under 35 U.S.C. Section 119(e) of U.S. Provisional Application Ser. No. 60/573,780, and which application is a continuation-in-part and claims the benefit under 35 U.S.C. Sections 119, 120 and/or 365 of U.S. Utility application Ser. No. 10/515,556, P.C.T. International Application Serial Number PCT/US04/23038, U.S. Utility application Ser. No. 11/126,587, and U.S. Utility application Ser. No. 11/134,883;

U.S. Utility application Ser. No. 11/158,527, filed Jun. 22, 2005, by F. Craig Farrill, entitled “PRESS-TO-CONNECT FOR WIRELESS COMMUNICATIONS SYSTEMS,” now U.S. Pat. No. 7,529,557, issued May 5, 2009, which application claims the benefit under 35 U.S.C. Section 119(e) of U.S. Provisional Application Ser. No. 60/581,954, and which application is a continuation-in-part and claims the benefit under 35 U.S.C. Sections 119, 120 and/or 365 of U.S. Utility application Ser. No. 10/515,556 and P.C.T. International Application Serial Number PCT/US04/23038;

U.S. Utility application Ser. No. 11/183,516, filed Jul. 18, 2005, by Deepankar Biswaas, entitled “VIRTUAL PUSH TO TALK (PTT) AND PUSH TO SHARE (PTS) FOR WIRELESS COMMUNICATIONS SYSTEMS,” which application claims the benefit under 35 U.S.C. Section 119(e) of U.S. Provisional Application Ser. No. 60/588,464;

U.S. Utility application Ser. No. 11/356,775, filed Feb. 17, 2006, by Krishnakant M. Patel, Bruce D. Lawler, Giridhar K. Boray, and Brahmananda R. Vempati, entitled “ENHANCED FEATURES IN AN ADVANCED VOICE SERVICES (AVS) FRAMEWORK FOR WIRELESS COMMUNICATIONS SYSTEMS,” now U.S. Pat. No. 7,813,722, issued Oct. 12, 2010, which application claims the benefit under 35 U.S.C. Section 119(e) of U.S. Provisional Application Ser. No. 60/654,271;

P.C.T. International Application Serial Number PCT/US2006/011628, filed Mar. 30, 2006, by Krishnakant M. Patel, Gorachand Kundu, Sameer Dharangaonkar, Giridhar K. Boray, and Deepankar Biswas, entitled “TECHNIQUE FOR IMPLEMENTING ADVANCED VOICE SERVICES USING AN UNSTRUCTURED SUPPLEMENTARY SERVICE DATA (USSD) INTERFACE,” which application claims the benefit under 35 U.S.C. Section 119(e) of U.S. Provisional Application Ser. No. 60/666,424;

U.S. Utility application Ser. No. 11/462,332, filed Aug. 3, 2006, by Deepankar Biswas, Krishnakant M. Patel, Giridhar K. Boray, and Gorachand Kundu, entitled “ARCHITECTURE AND IMPLEMENTATION OF CLOSED USER GROUP AND LIMITING MOBILITY IN WIRELESS NETWORKS,” now U.S. Pat. No. 7,689,238, issued Mar. 30, 2010, which application claims the benefit under 35 U.S.C. Section 119(e) of U.S. Provisional Application Ser. No. 60/705,115;

U.S. Utility application Ser. No. 11/463,186, filed Aug. 8, 2006, by Ravi Ayyasamy and Krishnakant M. Patel, entitled “ADVANCED VOICE SERVICES CLIENT FOR BREW PLATFORM,” now U.S. Pat. No. 8,036,692, issued Oct. 11, 2011, which application claims the benefit under 35 U.S.C. Section 119(e) of U.S. Provisional Application Ser. No. 60/706,265;

U.S. Utility application Ser. No. 11/567,098, filed Dec. 5, 2006, by Ravi Ayyasamy, Bruce D. Lawler, Krishnakant M. Patel, Vyankatesh V. Shanbhag, Brahmananda R. Vempati, and Ravi Shankar Kumar, entitled “INSTANT MESSAGING INTERWORKING IN AN ADVANCED VOICE SERVICES (AVS) FRAMEWORK FOR WIRELESS COMMUNICATIONS SYSTEMS,” which application claims the benefit under 35 U.S.C. Section 119(e) of U.S. Provisional Application Ser. No. 60/742,250;

U.S. Utility application Ser. No. 11/740,805, filed Apr. 26, 2007, by Krishnakant M. Patel, Giridhar K. Boray, Ravi Ayyasamy, and Gorachand Kundu, entitled “ADVANCED FEATURES ON A REAL-TIME EXCHANGE SYSTEM,” now U.S. Pat. No. 7,853,279, issued Dec. 14, 2010, which application claims the benefit under 35 U.S.C. Section 119(e) of U.S. Provisional Application Ser. No. 60/795,090;

U.S. Utility application Ser. No. 11/891,127, filed Aug. 9, 2007, by Krishnakant M. Patel, Deepankar Biswas, Sameer P. Dharangaonkar and Terakanambi Nanjanayaka Raja, entitled “EMERGENCY GROUP CALLING ACROSS MULTIPLE WIRELESS NETWORKS,” which application claims the benefit under 35 U.S.C. Section 119(e) of U.S. Provisional Application Ser. No. 60/836,521;

U.S. Utility application Ser. No. 12/259,102, filed on Oct. 27, 2008, by Krishnakant M. Patel, Gorachand Kundu, and Ravi Ayyasamy, entitled “CONNECTED PORTFOLIO SERVICES FOR A WIRELESS COMMUNICATIONS NETWORK,” which application claims the benefit under 35 U.S.C. Section 119(e) of U.S. Provisional Application Ser. Nos. 60/982,650 and 61/023,042;

U.S. Utility application Ser. No. 12/359,861, filed on Jan. 26, 2009, by Bruce D. Lawler, Krishnakant M. Patel, Ravi Ayyasamy, Harisha Mahabaleshwara Negalaguli, Binu Kaiparambil, Shiva Cheedella, Brahmananda R. Vempati, Ravi Shankar Kumar, and Avrind Shanbhag, entitled “CONVERGED MOBILE-WEB COMMUNICATIONS SOLUTION,” now U.S. Pat. No. 8,676,189, issued Mar. 18, 2014, which application claims the benefit under 35 U.S.C. Section 119(e) of U.S. Provisional Application Ser. No. 61/023,332;

U.S. Utility application Ser. No. 12/582,601, filed Oct. 20, 2009, by Krishnakant M. Patel, Ravi Ayyasamy, Gorachand Kundu, Basem A. Ardah, Anand Narayanan, Brahmananda R. Vempati, and Pratap Chandana, entitled “HYBRID PUSH-TO-TALK FOR MOBILE PHONE NETWORKS,” now U.S. Pat. No. 8,958,348, issued Feb. 17, 2015, which application claims the benefit under 35 U.S.C. Section 119(e) of U.S. Provisional Application Ser. No. 61/106,689;

U.S. Utility application Ser. No. 12/781,566, filed on May 17, 2010, by Bruce D. Lawler, Krishnakant M. Patel, Ravi Ayyasamy, Harisha Mahabaleshwara Negalaguli, Binu Kaiparambil, Shiva K. K. Cheedella, Brahmananda R. Vempati, and Ravi Shankar Kumar, entitled “CONVERGED MOBILE-WEB COMMUNICATIONS SOLUTION,” now U.S. Pat. No. 8,670,760, issued Mar. 11, 2014, which application is a continuation-in-part and claims the benefit under 35 U.S.C. Sections 119, 120 and/or 365 of U.S. Utility Application Ser. No. 12/582,601;

U.S. Utility application Ser. No. 12/750,175, filed on Mar. 30, 2010, by Bruce D. Lawler, Krishnakant M. Patel, Ravi Ayyasamy, Harisha Mahabaleshwara Negalaguli, Basem A. Ardah, Gorachund Kundu, Ramu Kandula, Brahmananda R. Vempati, Ravi Shankar Kumar, Chetal M. Patel, and Shiva K. K. Cheedella, entitled “ENHANCED GROUP CALLING FEATURES FOR CONNECTED PORTFOLIO SERVICES IN A WIRELESS COMMUNICATIONS NETWORK,” now U.S. Pat. No. 8,498,660, issued Jul. 30, 2013, which application claims the benefit under 35 U.S.C. Section 119(e) of U.S. Provisional Application Ser. Nos. 61/164,754 and 61/172,129;

U.S. Utility application Ser. No. 12/961,419, filed Dec. 6, 2010, by Ravi Ayyasamy, Bruce D. Lawler, Brahmananda R. Vempati, Gorachand Kundu and Krishnakant M. Patel, entitled “COMMUNITY GROUP CLIENT AND COMMUNITY AUTO DISCOVERY SOLUTIONS IN A WIRELESS COMMUNICATIONS NETWORK,” which application claims the benefit under 35 U.S.C. Section 119(e) of U.S. Provisional Application Ser. No. 61/266,896;

U.S. Utility application Ser. No. 13/039,635, filed on Mar. 3, 2011, by Narasimha Raju Nagubhai, Ravi Shankar Kumar, Krishnakant M. Patel, and Ravi Ayyasamy, entitled “PREPAID BILLING SOLUTIONS FOR PUSH-TO-TALK IN A WIRELESS COMMUNICATIONS NETWORK,” now U.S. Pat. No. 8,369,829, issued Feb. 5, 2013, which application claims the benefit under 35 U.S.C. Section 119(e) of U.S. Provisional Application Ser. No. 61/310,245;

U.S. Utility application Ser. No. 13/093,542, filed Apr. 25, 2011, by Brahmananda R. Vempati, Krishnakant M. Patel, Pratap Chandana, Anand Narayanan, Ravi Ayyasamy, Bruce D. Lawler, Basem A. Ardah, Ramu Kandula, Gorachand Kundu, Ravi Shankar Kumar, and Bibhudatta Biswal, and entitled “PREDICTIVE WAKEUP FOR PUSH-TO-TALK-OVER-CELLULAR (PoC) CALL SETUP OPTIMIZATIONS,” now U.S. Pat. No. 8,478,261, issued Jul. 2, 2013, which application claims the benefit under 35 U.S.C. Section 119(e) of U.S. Provisional Application Ser. No. 61/347,217;

U.S. Utility application Ser. No. 13/710,683, filed Dec. 11, 2012, by Ravi Ayyasamy, Gorachand Kundu, Krishnakant M. Patel, Brahmananda R. Vempati, Harisha M. Negalaguli, Shiva K. K. Cheedella, Basem A. Ardah, Ravi Shankar Kumar, Ramu Kandula, Arun Velayudhan, Shibu Narendranathan, Bharatram Setti, Anand Narayanan, and Pratap Chandana, entitled “PUSH-TO-TALK-OVER-CELLULAR (PoC),” which application claims the benefit under 35 U.S.C. Section 119(e) of U.S. Provisional Application Ser. No. 61/570,694;

U.S. Utility application Ser. No. 13/917,561, filed Jun. 13, 2013, by Krishnakant M. Patel, Brahmananda R. Vempati, Anand Narayanan, Gregory J. Morton, and Ravi Ayyasamy, entitled “RUGGEDIZED CASE OR SLEEVE FOR PROVIDING PUSH-TO-TALK (PTT) FUNCTIONS,” which application claims the benefit under 35 U.S.C. Section 119(e) of U.S. Provisional Application Ser. No. 61/659,292; U.S. Provisional Application Ser. No. 61/682,524; and U.S. Provisional Application Ser. No. 61/705,748;

U.S. Utility application Ser. No. 13/757,520, filed Feb. 1, 2013, by Krishnakant M. Patel, Harisha Mahabaleshwara Negalaguli, Brahmananda R. Vempati, Shiva Koteshwara Kiran Cheedella, Arun Velayudhan, Raajeev Kuppa, Gorachand Kundu, Ravi Ganesh Ramamoorthy, Ramu Kandula, Ravi Ayyasamy, and Ravi Shankar Kumar, entitled “WiFi INTERWORKING SOLUTIONS FOR PUSH-TO-TALK-OVER-CELLULAR (PoC),” now U.S. Pat. No. 9,088,876, issued Jul. 21, 2015, which application claims the benefit under 35 U.S.C. Section 119(e) of U.S. Provisional Application Ser. No. 61/593,485;

U.S. Utility application Ser. No. 14/093,240, filed Nov. 29, 2013, by Gorachand Kundu, Krishnakant M. Patel, Harisha Mahabaleshwara Negalaguli, Ramu Kandula, and Ravi Ayyasamy, entitled “METHOD AND FRAMEWORK TO DETECT SERVICE USERS IN INSUFFICIENT WIRELESS RADIO COVERAGE NETWORK AND IMPROVE SERVICE DELIVERY EXPERIENCE BY GUARANTEED PRESENCE,” now U.S. Pat. No. 9,137,646, issued Sep. 15, 2015, which application claims the benefit under 35 U.S.C. Section 119(e) of U.S. Provisional Application Ser. No. 61/730,856;

P.C.T. International Application Serial Number PCT/US2014/036414, filed May 1, 2014, by Krishnakant M. Patel, Harisha Mahabaleshwara Negalaguli, Arun Velayudhan, Ramu Kandula, Syed Nazir Khadar, Shiva Koteshwara Kiran Cheedella, and Subramanyam Narasimha Prashanth, entitled “VOICE-OVER-IP (VOIP) DENIAL OF SERVICE (DOS) PROTECTION MECHANISMS FROM ATTACK,” which application claims the benefit under 35 U.S.C. Section 119(e) of U.S. Provisional Application Ser. No. 61/818,109; and U.S. Provisional Application Ser. No. 61/821,975;

U.S. Utility application Ser. No. 14/286,427, filed May 23, 2014, by Krishnakant M. Patel, Ravi Ayyasamy and Brahmananda R. Vempati, entitled “METHOD TO ACHIEVE A FULLY ACKNOWLEDGED MODE COMMUNICATION IN PUSH-TO-TALK OVER CELLULAR (PoC),” which application claims the benefit under 35 U.S.C. Section 119(e) of U.S. Provisional Application Ser. No. 61/826,895;

P.C.T. International Application Serial Number PCT/US2014/047863, filed on Jul. 23, 2014, by Gorachand Kundu, Giridhar K. Boray, Brahmananda R. Vempati, Krishnakant M. Patel, Ravi Ayyasamy, and Harisha M. Negalaguli, entitled “EFFECTIVE PRESENCE FOR PUSH-TO-TALK-OVER-CELLULAR (PoC) NETWORKS,” which application claims the benefit under 35 U.S.C. Section 119(e) of U.S. Provisional Application Ser. No. 61/857,363; and U.S. Provisional Application Ser. No. 61/944,168;

P.C.T. International Application Serial Number PCT/US15/10617, filed Jan. 8, 2015, by Krishnakant M. Patel, Brahmananda R. Vempati, and Harisha Mahabaleshwara Negalaguli, entitled “OPTIMIZED METHODS FOR LARGE GROUP CALLING USING UNICAST AND MULTICAST TRANSPORT BEARER FOR PUSH-TO-TALK-OVER-CELLULAR (PoC),” which application claims the benefit under 35 U.S.C. Section 119(e) of U.S. Provisional Application Ser. No. 61/924,897;

U.S. Utility Application Ser. No. 14/639,794, filed Mar. 5, 2015, by Krishnakant M. Patel, Brahmananda R. Vempati, Ravi Ayyasamy, and Bibhudatta Biswal, entitled “PUSH-TO-TALK-OVER-CELLULAR (POC) SERVICE IN HETEROGENEOUS NETWORKS (HETNETS) AND MULTIMODE SMALL CELL ENVIRONMENTS,” which application claims the benefit under 35 U.S.C. Section 119(e) of U.S. Provisional Application Ser. No. 61/948,429;

P.C.T. International Application Serial Number PCT/US2014/047886, filed on Jul. 23, 2014, by Gorachand Kundu, Giridhar K. Boray, Brahmananda R. Vempati, Krishnakant M. Patel, Ravi Ayyasamy, Harisha Mahabaleshwara Negalaguli, and Ramu Kandula, entitled “RADIO ACCESS NETWORK (RAN) AWARE SERVICE DELIVERY FOR PUSH-TO-TALK-OVER-CELLULAR (PoC) NETWORKS,” which application is a continuation-in-part under 35 U.S.C. Section 120 of P.C.T. International Application Serial Number PCT/US2014/047863; and

P.C.T. International Application Serial Number PCT/US2015/45951, filed on Aug. 19, 2015, by Krishnakant M. Patel, Brahmananda R. Vempati, and Harisha Mahabaleshwara Negalaguli, entitled “RELAY-MODE AND DIRECT-MODE OPERATIONS FOR PUSH-TO-TALK-OVER-CELLULAR (PoC) USING WIFI TECHNOLOGIES,”, which application claims the benefit under 35 U.S.C. Section 119(e) of U.S. Provisional Application Ser. No. 62/039,272; all of which applications are incorporated by reference herein.

### BACKGROUND

1. Field of the Invention

This invention relates in general to advanced voice services in wireless communications networks, and more specifically, to a system and method for inter-communication between Land Mobile Radio (LMR) and Push-to-talk-over-Cellular (PoC) systems.

2. Description of Related Art

Advanced voice services (AVS), also known as Advanced Group Services (AGS), such as two-way half-duplex voice calls within a group, also known as Push-to-talk-over-Cellular (PoC), Push-to-Talk (PTT), or Press-to-Talk (P2T), as well as other AVS functions, such as Push-to-Conference (P2C) or Instant Conferencing (IC), Push-to-Message (P2M), etc., are described in the co-pending and commonly-assigned patent applications cross-referenced above and incorporated by reference herein. These AVS functions have enormous revenue earnings potential for wireless communications systems, such as cellular networks, wireless data networks and IP networks.

One approach to PoC is based on packet or voice-over-IP (VoIP) technologies. This approach capitalizes on the “bursty” nature of PoC conversations and makes network resources available only during talk bursts and hence is highly efficient from the point of view of network and spectral resources. This approach promises compliance with newer and emerging packet-based standards, such as GPRS (General Packet Radio Service), UMTS (Universal Mobile Telecommunications System), 3G/4G/LTE (3rd Generation/4th Generation/Long Term Evolution), etc.

Nonetheless, there is a need in the art for improvements to the methods and systems for delivering the advanced voice services, such as PoC, that comply with both existing and emerging wireless standards and yet provide superior user experiences. For example, many existing implementations of PoC do not support connections to different wireless networks. The present invention, on the other hand, satisfies the need for supporting connections to different wireless networks.

### SUMMARY

To overcome the limitations in the prior art described above, and to overcome other limitations that will become apparent upon reading and understanding the present specification, the present invention discloses a system and method for inter-communication between Land Mobile Radio (LMR) and Push-to-talk-over-Cellular (PoC) systems. The PoC system performs a PoC call session for one or more PoC mobile units in a first wireless network, wherein the PoC call session comprises an instant two-way half-duplex voice call within a group of the PoC mobile units. The LMR system performs a Push-to-Talk (PTT) call session for one or more LMR subscriber units in a second wireless network, wherein the PIT call session comprises an instant two-way half-duplex voice call within a group of the LMR subscriber units. A network-to-network interface (NNI) gateway provides for inter-communication between the PoC system in the first wireless network and the LMR system in the second wireless network, wherein the gateway bridges the LMR system to the PoC system, such that the PoC system is exposed to the LMR system as an emulated LMR system, the LMR system is exposed to the PoC system as an emulated PoC system, and calls may be placed across the first and second wireless networks between the PoC mobile units and LMR subscriber units.

The gateway creates and manages identifier mappings in order to make the PoC mobile units and their groups addressable by the LMR system, and to make the LMR subscriber units and their groups addressable by the PoC system. Specifically, the gateway exposes the LMR subscriber units and their groups to the PoC system using mobile and group identifiers of the first wireless network, and the gateway exposes the PoC mobile units and their groups to the LMR system using subscriber and group identifiers of the second wireless network.

The gateway may emulate an LMR system in another wireless network independent of the second wireless network. Alternatively, one or more of the LMR subscriber units may be homed in the PoC system and visiting the LMR system. Alternatively, the gateway may emulate a second LMR system in the second wireless network independent of the first LMR system.

### BRIEF DESCRIPTION OF THE DRAWINGS

Referring now to the drawings in which like reference numbers represent corresponding parts throughout:

FIG. 1 illustrates the system architecture used in one embodiment of the present invention.

FIG. 2 is a state diagram that illustrates the operation of a PoC session according to one embodiment of the present invention.

FIG. 3 is a simplified schematic based on FIG. 1 that further explains how inter-communication between the PoC system and the LMR system is accomplished by means of a network-to-network interface (NNI) Gateway that bridges the LMR system to the PoC system.

FIG. 4 is a schematic that illustrates how the Gateway emulates an LMR system in a different network.

FIG. 5 is a schematic that illustrates how the Gateway emulates an LMR system in the same network.

FIG. 6 is a schematic that illustrates a Master Media Function (MMF) and Subordinate Media Function (SMF) during a unit-to-unit call.

FIG. 7 is a call flow diagram for a unit-to-unit call originated in the LMR system.

FIG. 8 is a call flow diagram for a unit-to-unit call originated in the PoC system.

FIG. 9 is a schematic that illustrates the MMF and SMF during a group call.

FIG. 10 is a call flow diagram for a group call originated in the LMR system.

FIG. 11 is a call flow diagram for a group call originated in the PoC system.

### DETAILED DESCRIPTION OF ILLUSTRATIVE EMBODIMENTS

In the following description of the preferred embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

### 1 OVERVIEW

The present invention discloses a system for implementing advanced voice services in wireless communications networks that provides a feature-rich server architecture with a flexible client strategy. Specifically, the present invention is directed to a Push-to-talk-over-Cellular (PoC) system that inter-communicates with a Land Mobile Radio (LMR) system.

The PoC system disclosed herein system is an Open Mobile Alliance (OMA) standards-compliant solution that can be easily deployed, thereby enabling carriers to increase their profits, improve customer retention and attract new customers without costly upgrades to their network infrastructure. This system is built on a proven, reliable all-IP (Internet Protocol) platform. The highly scalable platform is designed to allow simple network planning and growth. Multiple servers can be distributed across operator networks for broad geographic coverage and scalability to serve a large and expanding subscriber base.

### 1.1 Definitions

The following table defines various acronyms, including industry-standard acronyms, that are used in this specification.

| Acronym | Description |
|---|---|
| ATCA | Advanced Telecommunications Computing Architecture |
| DnD | Do not Disturb |
| DNS | Domain Name Server |
| MBMS/eMBMS | Multimedia Broadcast Multicast Services |
| GPRS | General Packet Radio Service |
| GSM | Global System for Mobile communications |
| GTM | Global Traffic Manager |
| GTP | GPRS Tunneling Protocol |
| HTTP | Hypertext Transport Protocol |
| HTTPS | Secure Hypertext Transport Protocol |
| IMSI | International Mobile Subscriber Identity |
| IP | Internet Protocol |
| IPA | Instant Personal Alert |
| LMR | Land Mobile Radio |
| MBCP | Media Burst Control Protocol |
| MCC | Mobile Country Code |
| MDN | Mobile Directory Number |
| MNC | Mobile Network Code |
| MS-ISDN | Mobile Station International Subscriber Directory |
| | Number |
| OMA | Open Mobile Alliance |
| PoC | Push-to-talk-over-Cellular |
| PGW | Packet GateWay |
| PTT | Push-To-Talk |
| RTCP | Realtime Transport Control Protocol |
| RTP | Realtime Transport Protocol |
| SDP | Session Description Protocol |
| SIM | Subscriber Identity Module |
| SIP | Session Initiation Protocol |
| SMMP | Short Message peer-to-peer Protocol |
| SMS | Small Message Service |
| SRTP | Secure Real-time Transport Protocol |
| SSL | Secure Sockets Layer protocol |
| SSRC | Synchronization SouRCe |
| TLS | Transport Layer Security protocol |
| UDP | User Datagram Protocol |
| URI | Uniform Resource Identifier |
| VoIP | Voice-over-IP |
| VPN | Virtual Private Network |
| SGW | Serving GateWay |
| XCAP | XML Configuration Access Protocol |
| XDM | XML Document Management |
| XML | Extensible Mark-up Language |
| 4G/LTE | 4^{th} Generation/Long Term Evolution |

The following table defines various terms, including industry-standard terms, that are used in this specification.

| Term | Description |
|---|---|
| 1-1 PoC Session | A feature enabling a PoC User to establish a PoC Session with another |
| | PoC User. |
| Ad Hoc PoC Group | A PoC Group Session established by a PoC User to PoC Users listed on |
| Session | the invitation. The list includes PoC Users or PoC Groups or both. |
| Answer Mode | A PoC Client mode of operation for the terminating PoC Session |
| | invitation handling. |
| Controlling PoC | A function implemented in a PoC Server, providing centralized PoC |
| Function | Session handling, which includes media distribution, Talk Burst |
| | Control, Media Burst Control, policy enforcement for participation in |
| | the PoC Group Sessions, and participant information. |
| Corporate | These subscribers will only receive contacts and groups from a |
| | corporate administrator. That means they cannot create their own |
| | contacts and groups from handset. |
| Corporate Public | These subscribers receive contacts and groups from a corporate |
| | administrator in addition to user-created contacts and groups. |
| Corporate | A user who manages corporate subscribers, their contacts and groups. |
| Administrator | |
| Firewall | A device that acts as a barrier to prevent unauthorized or unwanted |
| | communications between computer networks and external devices. |
| Home PoC Server | The PoC Server of the PoC Service Provider that provides PoC service |
| | to the PoC User. |
| Instant Personal | A feature in which a PoC User sends a SIP based instant message to a |
| Alert | PoC User requesting a 1-1 PoC Session. |
| Law Enforcement | An organization authorized by a lawful authorization based on a |
| Agency | national law to request interception measures and to receive the |
| | results of telecommunications interceptions. |
| Lawful Interception | The legal authorization, process, and associated technical capabilities |
| | and activities of Law Enforcement Agencies related to the timely |
| | interception of signaling and content of wire, oral, or electronic |
| | communications. |
| Notification | A message sent from the Presence Service to a subscribed watcher |
| | when there is a change in the Presence Information of some presentity |
| | of interest, as recorded in one or more Subscriptions. |
| Participating PoC | A function implemented in a PoC Server, which provides PoC Session |
| Function | handling, which includes policy enforcement for incoming PoC |
| | Sessions and relays Talk Burst Control and Media Burst Control |
| | messages between the PoC Client and the PoC Server performing the |
| | Controlling PoC Function. The Participating PoC Function may also |
| | relay RTP Media between the PoC Client and the PoC Server |
| | performing the Controlling PoC Function. |
| PoC Client | A functional entity that resides on the User Equipment that supports |
| | the PoC service. |
| Pre-Arranged PoC | A SIP URI identifying a Pre-Arranged PoC Group. A Pre-Arranged PoC |
| Group Identity | Group Identity is used by the PoC Client, e.g., to establish PoC Group |
| | Sessions to the Pre-Arranged PoC Groups. |
| Pre-Arranged PoC | A persistent PoC Group. The establishment of a PoC Session to a Pre- |
| Group | Arranged PoC Group results in the members being invited. |
| Pre-Established | The Pre-Established Session is a SIP Session established between the |
| Session | PoC Client and its Home PoC Server. The PoC Client establishes the |
| | Pre-Established Session prior to making requests for PoC Sessions to |
| | other PoC Users. To establish a PoC Session based on a SIP request |
| | from the PoC User, the PoC Server conferences other PoC Servers or |
| | users to the Pre-Established Session so as to create an end-to-end |
| | connection. |
| Presence Server | A logical entity that receives Presence Information from a multitude of |
| | Presence Sources pertaining to the Presentities it serves and makes |
| | this information available to Watchers according to the rules |
| | associated with those Presentities. |
| Presentity | A logical entity that has Presence Information associated with it. This |
| | Presence Information may be composed from a multitude of Presence |
| | Sources. A Presentity is most commonly a reference for a person, |
| | although it may represent a role such as “help desk” or a resource such |
| | as “conference room #27”. The Presentity is identified by a SIP URI, |
| | and may additionally be identified by a tel URI or a pres URI. |
| Public | These subscribers create and manage their contacts and groups. |
| Serving Server | A set of primary and secondary servers. |
| Subscription | The information kept by the Presence Service about a subscribed |
| | watcher's request to be notified of changes in the Presence |
| | Information of one or more Presentities. |
| Watcher | Any uniquely identifiable entity that requests Presence Information |
| | about a Presentity from the Presence Service. |
| WiFi | A wireless local area network (WLAN). |

### 2 SYSTEM ARCHITECTURE

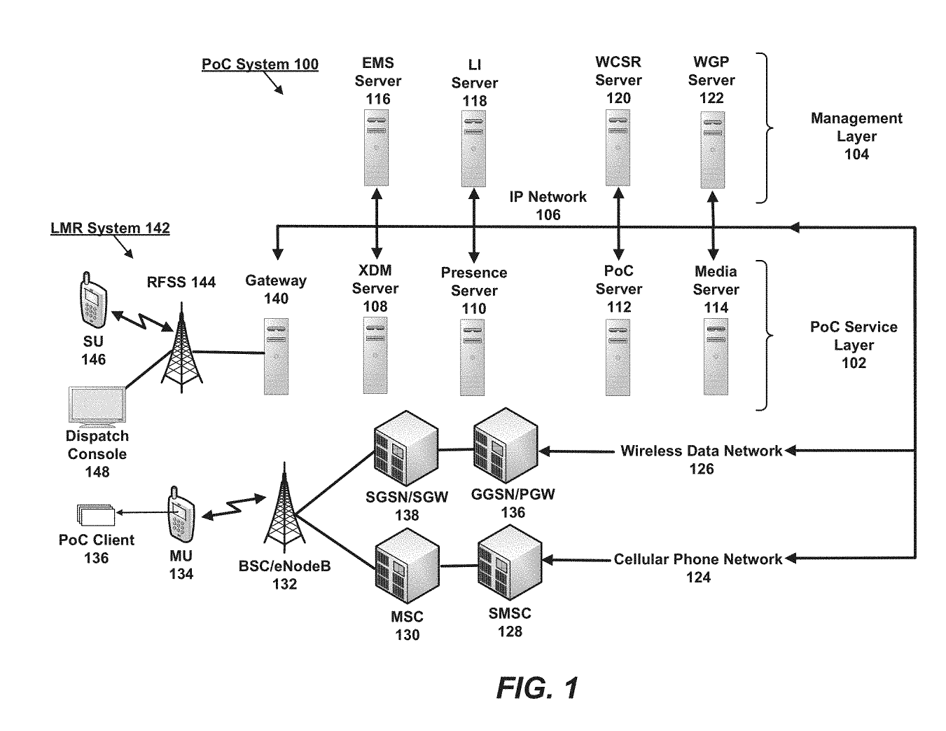

FIG. 1 illustrates the system architecture used in the present invention. This architecture conforms to the Advanced Telecommunications Computing Architecture (ATCA) standard to support the advanced voice services of the present invention. ATCA is an open standards-based, high-availability telecommunications platform architecture.

Preferably, the PoC system 100 includes one or more PoC Service Layers 102 and one or more Management Layers 104, each of which is comprised of one or more servers interconnected by one or more IP networks 106. Specifically, the PoC Service Layer 102 includes one or more XML Document Management (XDM) Servers 108, Presence Servers 110, PoC Servers 112, and Media Servers 114, while the Management Layer 104 includes one or more Element Management System (EMS) Servers 116, Lawful Intercept (LI) Servers 118, Web Customer Service Representative (WCSR) Servers 120, and Web Group Provisioning (WGP) Servers 122. These various servers are described in more detail below.

The PoC Service Layer 102 and Management Layer 104 are connected to one or more wireless communications networks, such as cellular phone networks 124 and wireless data networks 126, as well as one or more IP networks 106. Note that the cellular phone networks 124 and wireless data networks 126 may be implemented in a single network or as separate networks. The cellular phone network 124 includes one or more Short Message Service Centers (SMSCs) 128, Mobile Switching Centers (MSCs) 130, and Base Station Components (BSCs) 132, wherein the BSCs 132 include controllers and transceivers that communicate with one or more customer handsets 134 executing a PoC Client 136. A handset 134 is also referred to herein as a PoC mobile unit, mobile station, mobile phone, cellular phone, etc. and may comprise any wireless and/or wired device. The wireless data network 126, depending on its type, e.g., GPRS or 4G/LTE, includes one or more Gateway GPRS Support Nodes (GGSNs) or Packet Gateways (PGWs) 136 and Serving GPRS Support Nodes (SGSNs) or Serving GateWays (SGWs) 138, which also communicate with PoC mobile units 134 via BSCs or eNodeBs 132.

Finally, in one embodiment of the present invention, the PoC Service Layer 102 and Management Layer 104 are connected to one or more Gateways 140, which are coupled to one or more external wireless networks, such as a Land Mobile Radio (LMR) system 142. The LMR system 142 includes one or more Radio Frequency (RF) Sub-Systems (RFSS's) 144 that communicate with one or more LMR subscriber units 146 as well as Dispatch Consoles 148. The Gateway 140 performs inter-communication or interworking between the PoC system wo and the LMR system 142, as described in more detail below in Section 5.

### 2.1 Cellular Phone Network

The PoC Service Layer 102 interacts with the SMSC 128 on the cellular phone network 124 to handle Short Message Service (SMS) operations, such as routing, forwarding and storing incoming text messages on their way to desired endpoints.

### 2.2 Wireless Data Network

The PoC Service Layer 102 also interacts with the following entities on the wireless data network 126:
The GGSN/PGW 136 transfers IP packets between the PoC Client 136 and the various servers:
   SIP/IP signaling messages between the PoC Server 112 and PoC Client 136 for control traffic exchange (i.e., control packets) for PoC call sessions.
   RTP/IP, RTCP/IP and MBCP/IP packets between the Media Server 114 and PoC Client 136 for bearer traffic exchange (i.e., voice packets) for PoC call sessions.
   SIP/IP signaling messages between the Presence Server no and PoC Client 136 for presence information.
   XCAP/HTTP/IP and SIP/IP signaling between the XDM Server 108 and PoC Client 136 for document management.
The SMSC 128 handles authentication:
   The XDM Server 108 communicates with the SMSC 128 via SMPP/IP for receiving the authentication code required for PoC Client 136 activation from the PoC mobile unit 134.

### 2.3 Other IP Networks

The PoC system 100 also has the capability to interact with PoC mobile units 134 on other IP networks (not shown), such as the Internet, as well as private or public wireless or and/or wireline IP networks. In this regard, the PoC Service Layer 102 also interacts with the following entities on other IP networks:
The Gateway 140 transfers IP packets between the PoC Client 136 and the various servers:
   SIP/IP signaling messages between the PoC Server 112 and PoC Client 136 for control traffic exchange (i.e., control packets) for PoC call sessions.
   RTP/IP, RTCP/IP and MBCP/IP packets between the Media Server 114 and PoC Client 136 for bearer traffic exchange (i.e., voice packets) for PoC call sessions.
   SIP/IP signaling messages between the Presence Server no and PoC Client 136 for presence information.
   XCAP/HTTP/IP and SIP/IP signaling between the XDM Server 108 and PoC Client 136 for document management.
   SIP/IP signaling messages between the XDM Server 108 and PoC Client 136 for receiving the authentication code required for PoC Client 136 activation from the PoC mobile unit 134.

### 2.4 PoC Service Layer Elements

As noted above, the PoC Service Layer 102 is comprised of the following elements:
PoC Server 112,
Media Server 114,
Presence Server 110,
XDM Server 108, and
Gateway 140.

These elements are described in more detail below.

2.4.1 PoC Server

The PoC Server 112 handles the PoC call session management and is the core for managing the PoC services for the PoC Clients 136 using SIP protocol. The PoC Server 112 implements a Control Plane portion of Controlling and Participating PoC Functions. A Controlling PoC Function acts as an arbitrator for a PoC Session and controls the sending of control and bearer traffic by the PoC Clients 136. A Participating PoC Function relays control and bearer traffic between the PoC Client 136 and the PoC Server 112 performing the Controlling PoC Function.

2.4.2 Media Server

The Media Server 114 implements a User Plane portion of the Controlling and Participating PoC Functions. The Media Server 114 supports the Controlling PoC Function by duplicating voice packets received from an originator PoC Client 136 to all recipients of the PoC Session. The Media Server 114 also supports the Participating PoC Function by relaying the voice packets between PoC Clients 136 and the Media Server 114 supporting the Controlling PoC Function. The Media Server 114 also handles packets sent to and received from the PoC Clients 136 for floor control during PoC call sessions.

2.4.3 Presence Server

The Presence Server no implements a presence enabler for the PoC Service. The Presence Server no accepts, stores and distributes Presence Information for Presentities, such as PoC Clients 136.

The Presence Server no also implements a Resource List Server (RLS), which accepts and manages subscriptions to Presence Lists. Presence Lists enable a “watcher” application to subscribe to the Presence Information of multiple Presentities using a single subscription transaction.

The Presence Server no uses certain XDM functions to provide these functions, which are provided by XDM Server 108.

2.4.4 XDM Server

The XDM Server 108 implements an XDM enabler for the PoC Service. The XDM enabler defines a common mechanism that makes user-specific service-related information accessible to the functions that need them. Such information is stored in the XDM Server 108 where it can be located, accessed and manipulated (e.g., created, changed, deleted, etc.). The XDM Server 108 uses well-structured XML documents and HTTP protocol for access and manipulation of such XML documents. The XDM Server 108 also connects to the operator SMSC 128 for the purposes of PoC Client 136 activation using SMS. In addition, the XDM Server 108 maintains the configuration information for all PoC subscribers.

2.4.5 Gateway

The Gateway 140 implements an inter-communication or interworking solution for the PoC Service to communicate via one or more LMR systems 142. Specifically, the Gateway 140 provides PoC Service to the LMR system 142, and supports a seamless user experience while the transport of IP control messages and IP voice data is transitioned between the PoC system 100 and the LMR system 142. The Gateway 140 also resolves security concerns that arise with such inter-communication or interworking solutions. These and other aspects of the inter-communication or interworking solution are described in more detail below in Section 5.

### 2.5 Management Layer Elements

As noted above, the Management Layer 104 is comprised of the following elements:
Element Management System (EMS) Server 116,
Lawful Intercept (LI) Server 118,
Web Group Provisioning (WGP) Server 122, and
Web Customer Service Representative (WCSR) Server 120.

These elements are described in more detail below.

2.5.1 EMS Server

The EMS Server 116 is an operations, administration, and maintenance platform for the PoC system 100. The EMS Server 116 enables System Administrators to perform system-related configuration, network monitoring and network performance data collection functions. The EMS Server 116, or another dedicated server, may also provide billing functions. All functions of the EMS Server 116 are accessible through a web-based interface.

2.5.2 LI Server

The LI Server 118 is used for tracking services required by various Lawful Enforcement Agents (LEAs). The LI Server 118 generates and pushes an IRI (Intercept Related Information) Report for all PoC Services used by a target. The target can be added or deleted in to the PoC Server 112 via the LI Server 118 using a Command Line Interface (CLI).

2.5.3 WGP Server

The WGP Server 122 provides a web interface for Corporate Administrators to manage PoC contacts and groups. The web interface includes contact and group management operations, such as create, delete and update contacts and groups.

2.5.4 WCSR Server

The WCSR Server 120 provides access to customer service representatives (CSRs) for managing end user provisioning and account maintenance.

Typically, it supports the following operations:
Create Subscriber account,
Update Subscriber account,
Delete Subscriber account,
Mobile number change command,
View Subscriber details (MDN, Group, Group members),
Manage Corporate Accounts,
Add CSR account,
Delete CSR account.

### 3 SYSTEM FUNCTIONS

The following sections describe various functions performed by each of the components of the system architecture.

### 3.1 PoC Service Layer

3.1.1 PoC Server

The PoC Server 112 controls PoC call sessions, including 1-1, Ad Hoc and Pre-Arranged PoC call sessions. The PoC Server 112 also controls Instant Personal Alerts.

The PoC Server 112 expects the PoC Clients 136 to setup “pre-established sessions” at the time of start up and use these sessions to make outgoing PoC calls. The PoC Server 112 also uses pre-established sessions to terminate incoming PoC calls to the PoC Clients 136. The PoC Clients 136 are setup in auto-answer mode by default. The use of pre-established sessions and auto-answer mode together allow for faster call setup for PoC call sessions.

The PoC Server 112 allocates and manages the media ports of the Media Services 114 associated with each SIP INVITE dialog for pre-established sessions and controls the Media Servers 114 to dynamically associate these ports at run time for sending RTP packets during PoC call sessions. Media ports are assigned and tracked by the PoC Server 112 at the time of setting up pre-established sessions. The PoC Server 112 instructs the Media Server 114 to associate the media ports of various subscribers dynamically into a session when a PoC call is originated and this session is maintained for the duration of the call. The PoC Server 112 also controls the floor states of the various participants in a PoC call session by receiving indications from the Media Servers 114 and sending appropriate requests back to the Media Servers 114 to send MBCP messages to the participants in the PoC call. The Media Server 114 uses the media ports association and current talker information to send the RTP packets from the talker's media port onto the listeners' media ports.

In addition, the PoC Server 112 handles the incoming and outgoing Instant Personal Alerts (IPAs) by routing SIP MESSAGE requests to the PoC Clients 136 and remote PoC Servers 112 for final delivery as applicable.

The PoC Server 112 uses static and dynamic data related to each subscriber to perform these functions. Static data include subscriber profile, contacts and groups. Dynamic data include the subscriber's registration state, PoC settings and SIP dialog states are maintained only on the PoC Server 112.

3.1.2 Media Server

The Media Server 114 handles the flow of data to and from the PoC Clients 136 as instructed by the PoC Server 112. Each Media Server 114 is controlled by a single PoC Server 112, although multiple Media Servers 114 may be controlled by a PoC Server 112 simultaneously.

The Media Server 114 is completely controlled by the PoC Server 112. As noted above, even the media ports of the Media Server 114 are allocated by the PoC Server 112 and then communicated to the Media Server 114. Likewise, floor control requests received by the Media Server 114 from PoC Clients 136 are sent to the PoC Server 112, and the PoC Server 112 instructs the Media Server 114 appropriately. Based on these instructions, the Media Server 114 sends floor control messages to the PoC Clients 136 and sends the RTP packets received from the talker to all the listeners.

3.1.3 Presence Server

The Presence Server no accepts presence information published by PoC Clients 136, as well as availability information received from other entities. The Presence Server no keeps track of these presence states and sends notifications to various “watcher” applications whenever a presence state changes. The Presence Server no maintains separate subscriptions for each watcher and dynamically applies the presence authorization rules for each watcher independently.

The Presence Server no also accepts resource list subscriptions from the watchers, which identify one or more entities (“Presentities”) whose presence should be monitored. The Presence Server no then aggregates all the presence information into one or more presence notifications transmitted to each watcher. This allows watchers to subscribe to large number of Presentities without putting strain on the network as well as client and server resources.

3.1.4 XDM Server

The XDM Server 108 performs client authentication and subscription functions. The XDM Server 108 also stores subscriber and group information data. The XDM Server 108 also interacts with the SMSC 128 to receive PoC Client 136 activation commands.

All subscriber provisioning and CSR operations in the XDM Server 108 are performed through the WCSR Server 120, while corporate administrative operations, as well as contacts and group management, are handled through the WGP Server 122.

The XDM Server 108 includes a Subscriber Profile Manager module that provides subscriber management functionality, such as creation, deletion and modification of subscriber profiles. The subscriber profile includes data such as the MDN, subscriber name, subscriber type, etc. This also determines other system-wide configurations applicable for the subscriber including the maximum number of contacts and groups per subscriber and the maximum number of members per group.

The XDM Server 108 includes a Subscriber Data Manager module that manages the subscriber document operations, such as contact and group management operations, initiated by the PoC Clients 136 or the WGP Server 122.

3.2 Management Layer

3.2.1 EMS Server

The EMS Server 116 is the central management entity in the system and includes the following modules:
A central application where all management business logic resides.
A web server for serving the network operator's internal users. A corresponding client provides a user interface for viewing fault, configuration, performance and security information.
A subsystem is provided for health monitoring of network elements deployed in the system and also to issue any maintenance commands as applicable.

3.2.2 WCSR Server

The WCSR Server 120 provides a web user interface for customer service representatives (CSRs) to carry out various operations. The web user interface provides access to CSRs for managing subscriber provisioning and account maintenance. Typically, it supports the following operations.
Create Subscriber account,
Update Subscriber account,
Delete Subscriber account,
Mobile number change command,
Forced synchronization of a Subscriber,
Deactivate a Subscriber account,
Reactivate a Subscriber account,
View Subscriber details, such as MDN, Group, Group members.

3.2.3 WGP Server

The WGP Server 122 allows provides for central management of all corporate subscribers and associated contacts and groups within a corporation. The WGP Server 122 allows Corporate Administrators to manage contacts and groups for corporate subscribers.

The WGP Server 122 includes a Corporate Administration Tool (CAT) that is used by Corporate Administrators to manage contacts and groups of corporate subscribers. The CAT has a Web User Interface for Corporate Administrators that supports the following operations:
Group management,
Contact management, and
Associations between corporations.

With regard to group management, the CAT of the WGP Server 122 includes the following operations:
Create, Update, Delete and View Corporate Groups,
Add, Update, Delete and View Members of a Corporate Group,
Manage Subscribers,
Activate and Deactivate a Corporate Subscriber,
Change a Subscriber type from “Corporate” to “Corporate And Public”, and vice versa,
Restrict Availability, i.e., do not allow subscriber to change their presence status, and
Manage number porting or name change via phone assignment.

With regard to contact management, the CAT of the WGP Server 122 includes the following operations:
Phone list management,
N×N Contact Add (e.g., N contacts may be members of N groups),
Add, Update, Delete and View Contacts for a specific subscriber, and
Export and Import contacts at both the subscriber and corporate level.

With regard to associations between corporations, the CAT of the WGP Server 122 includes the following operations:
Corporate Associations Attributes,
Association Name,
Association ID,
Association Mode (e.g., One-way, Two-way), and
Restricted List.

Once the association is created and accepted, Corporate Administrators can create contacts and groups using the association policies. Administrators from other corporations can view the contacts, and may or may not have the capability to add, update or delete the contacts.
Corporate ID associated per corporate subscriber,
Central management of corporate subscribers, groups, and contacts,
Intercorporate associations, including contacts and white-lists,
Phone list management (e.g., N×N contact add),
Restrict Availability, and
Import and Export contacts at both the subscriber and corporate level.

Note that, if the association is deleted, then usually all intercorporate contacts and group members will be deleted.

### 3.3 PoC Client

The PoC Client 136 is an OMA-compatible client application executed on a PoC mobile unit 134. The following features are supported by the PoC Client 136:
PoC Calls and Instant Personal Alert,
Presence, and
Contact and Group Management.

The PoC Client 136 includes a database module, a presence module, an XDM module and a client module.

The database module stores configuration information, presence information, contact and group information, user settings, and other information in an optimized and persistent way. Information is preserved when the user unregisters with the PoC Server 112 or power cycles the device. The database module also has a mechanism to reset the data and synchronize from the XDM Server 108 when the data in the database module is corrupt or unreadable.

The presence module creates and maintains the presence information for the subscriber. Typically, the presence information supports Available, Unavailable and Do-not-Disturb (DnD) states. The presence module also subscribes to the Presence Server no as a “watcher” of all contacts in the PoC mobile unit 134 and updates the user interface of the PoC mobile unit 134 whenever it receives a notification with such presence information.

The XDM module communicates with the XDM Server 108 for management of contacts and groups. The XDM module may subscribe with the XDM Server 108 to send and receive any changes to the contacts or group list, and updates the user interface of the PoC mobile unit 134 based on the notifications it receives from the XDM Server 108.

The client module provides the most important function of making and receiving PoC calls. To support PoC calls, the client module creates and maintains pre-established sessions with the PoC Server 112. The client module supports 1-1, Ad Hoc and Pre-Arranged PoC calls. The client module also supports sending and receiving Instant Personal Alerts (IPA).

### 4 STATE DIAGRAM FOR A POC CALL SESSION

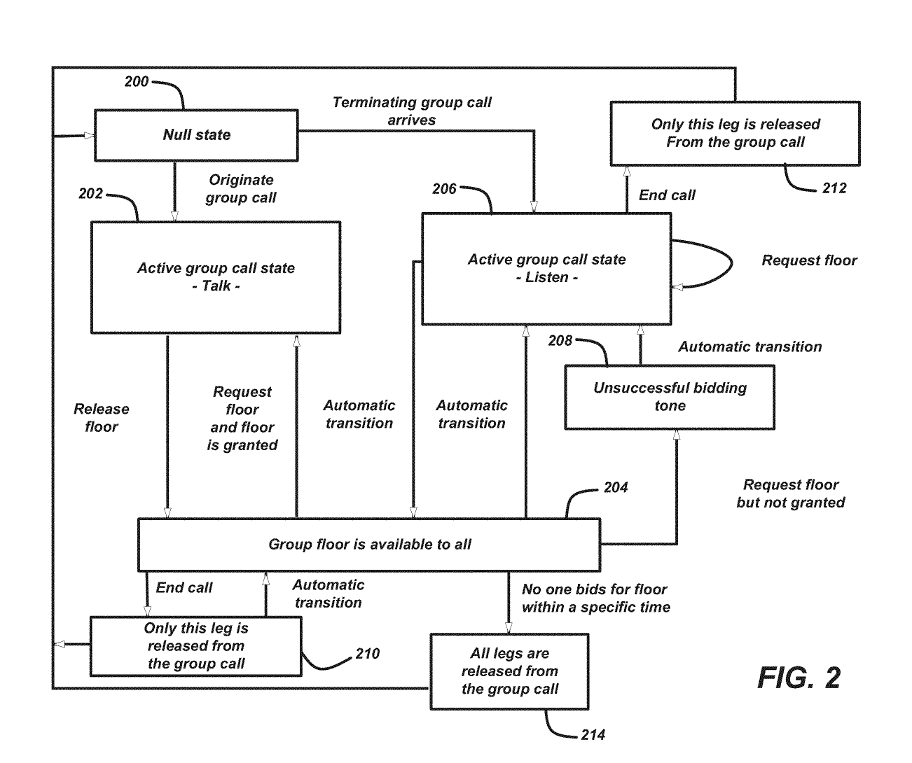

FIG. 2 is a state diagram that illustrates the operation of a PoC call session in the PoC system 100 according to one embodiment of the present invention.

State 200 represents a PoC Client 136 in a NULL state, i.e., the start of the logic. A transition out of this state is triggered by a user making a request to originate a PoC call, or by a request being made to terminate a PoC call at the PoC mobile unit 134. A request to originate a PoC call is normally made by pressing a PoC button, but may be initiated in this embodiment by dialing some sequence of one or more numbers on the PoC mobile unit 134 that are interpreted by the PoC Server 112, by pressing one or more other keys on the PoC mobile unit 134 that are interpreted by the PoC Server 112, by speaking one or more commands that are interpreted by the PoC Server 112, or by some other means.

State 202 represents the PoC Client 136 in an active group call state, having received a “floor grant” (permit to speak). In this state, the user receives a chirp tone that indicates that the user may start talking. The user responds by talking on the PoC mobile unit 134. The PoC mobile unit 134 uses the reverse traffic channel to send voice frames to the Media Server 114, and the Media Server 114 switches voice frames only in one direction, i.e., from talker to one or more listeners, which ensures the half-duplex operation required for a PoC call.

State 204 represents the group “floor” being available to all members of the group. When the talking user signals that the floor is released, the floor is available to all group members. The signal to release the floor is normally made by releasing the PoC button, but may be performed in this embodiment by voice activity detection, e.g., by not speaking for some time period (which is interpreted by the PoC Server 112 as a release command). All members of the group receive a “free floor” tone on their PoC mobile unit 134. A user who requests the floor first (in the “free-floor” state), for example, is granted the floor, wherein the PoC system 100 sends a chirp tone to the successful user. The signal to request the floor is normally made by pressing the PoC button, but may be performed in this embodiment by voice activity detection, e.g., by speaking for some time period (which is interpreted by the PoC Server 112 as a request command).

State 206 represents the PoC Client 136 being in an active group call state. In this state, the user is listening to the group call. If a non-talking user requests the floor in the active group call state, the user does not receive any response from the PoC system 100 and remains in the same functional state. As noted above, the signal to request the floor is normally made by pressing the PoC button, but may be performed in this embodiment by voice activity detection, e.g., by speaking for some time period (which is interpreted by the PoC Server 112 as a request command).

State 208 represents a user receiving an “unsuccessful bidding” tone on his PoC mobile unit 134, after the user has requested the floor, but was not granted the floor, of the group call. The user subsequently listens to the voice message of the talking user.

Non-talking users (including the talking user who must release the floor to make it available for others) can request the PoC system 100 to end their respective call legs explicitly.

State 210 represents a terminating leg being released from the call after the user ends the call.

State 212 also represents a terminating leg being released from the call after the user ends the call.

State 214 represents all terminating legs being released from the call when no user makes a request for the within a specified time period, or after all users have ended their respective call legs.

### 5 INTER-COMMUNICATION BETWEEN THE LMR AND POC SYSTEMS

### 5.1 Overview

Among the prevalent PoC/PTT technologies, LMR systems serve a large segment of users. This invention describes an implementation for the Gateway 140 that enables the PoC system 100 to connect with the LMR system 142 for the provision of 1-on-1 as well as group calls between the systems 100, 142.

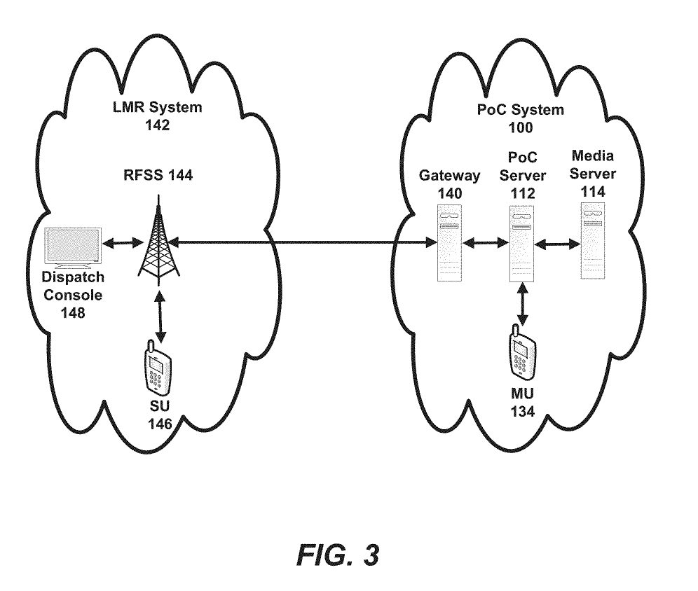

FIG. 3 is a simplified schematic based on FIG. 1 that further explains how interworking or inter-communication between the PoC system 100 and the LMR system 142 is accomplished by the Gateway 140 that bridges the LMR system 142 to the PoC system 100. Specifically, the Gateway 140 causes the PoC system 100 to be exposed to the LMR system 142 as an emulated LMR system, and causes the LMR system 142 to be exposed to the PoC system 100 as an emulated PoC system. These functions of the Gateway 140 described in more detail below.

The Gateway 140 increases the interface options for both the PoC system 100 and the LMR system 142. As a result, the use of the Gateway 140 to bridge the PoC system 100 and the LMR system 142 should increase user adoption and reduce user churn in both systems 100, 142. Moreover, Gateway 140 offers standards-based interfaces that extend the features of both systems 100, 142.

### 5.2 Project 25 (P25) Description

In one embodiment, the LMR system 142 is based on the Project 25 (P25) standard. The P25 standard was developed for public safety wireless networks by the Association of Public Safety Communications Officials (APCO) in conjunction with the Telecommunications Industry Association (TIA). However, other types of standards, wireless networks and/or systems may benefit from the present invention as well.

In the P25 standard, the LMR system 142 is comprised of at least one base station, known as a Radio Frequency (RF) Sub-System (RFSS) 144, that connects via an air interface to one or more portable radios or other mobile devices, known as LMR subscriber units (SUs) 146. An Inter-RF Sub-System Interface (ISSI) is used to connect different RFSS's 144 together to form a larger wireless network with a larger coverage area. Other peripherals may be attached to the RFSS's 144, such as a Dispatch Console 148 connected by means of a Console Sub-System Interface (CSSI).

Like the PoC system 100, the LMR system 142 can perform a group PIT call among the LMR subscriber units 146, i.e., a call in which one member of a group can speak to all other members simultaneously. For example, all police officers on patrol could constitute one group. In order to facilitate communications in an orderly manner, a floor control mechanism is used to arbitrate who should speak in the event two and more members request to speak at the same time. As is known, a PTT user who wants to speak to the group will push a button on their LMR subscriber unit 146. A message would then be sent to the RFSS 144, which arbitrates all the talk requests and either grants or denies each request by sending a response back to the requesters.

A collection of one or more LMR systems 142 is uniquely identified by a Wide Area Communication Network (WACN) ID as a separate and independent wireless network. Each LMR system 142, which is a collection of one or more RFSS's 144 across a defined coverage area, is uniquely identified by its combined WACN ID and System ID. Similarly, each RFSS 144 is uniquely identified by its combined WACN ID, System ID and RFSS ID.

As noted above, PoC mobile units 134 are identified by MDNs and Group IDs. LMR subscriber units 146, on the other hand, are identified by subscriber IDs (SU-IDs) and subscriber group IDs (SG-IDs). The Gateway 140 creates and manages ID mappings in order to make PoC mobile units 134 and their groups addressable by the LMR system 142, and to make LMR subscriber units 146 and their groups addressable by the PoC system 100. Specifically, the Gateway 140 exposes PoC mobile units 134 and their groups to the LMR system 142 using pseudo-SU-IDs and pseudo-SG-IDs, and exposes LMR subscriber units 146 and their groups to the PoC system 100 using pseudo-MDNs and pseudo-Group IDs.

### 5.3 ISSI and CSSI Protocols

The Gateway 140 enables the PoC mobile units 134 of the PoC system 100 to communicate with the LMR system 142 using ISSI/CSSI. The PoC system 100 is connected to the Gateway 140 through a PoC NNI, and this allows the PoC system 100 to be insulated from the different variants of the ISSI/CSSI protocols that may be used between the Gateway 140 and various LMR systems 142.

ISSI is an open interface that can connect RFSS's 144 within and among LMR systems 142 in the same or different WACNs via dedicated links or a VPN. ISSI is used to pass voice and call data between systems. ISSI relies on standard IP protocols for voice transport, using Realtime Transport Protocol (RTP), and call signaling, using Session Initiation Protocol (SIP).

CSSI is used for interfacing an RFSS 144 with a Dispatch Console 148. CSSI is the same as ISSI with minor extensions for supporting some console specific use cases.

ISSI supports authentication and registration of roaming LMR subscriber units 146. For example, ISSI allows LMR subscriber units 146 from network A to operate under the coverage of network B assuming the same frequency band. This includes the capability for network A to track and control its LMR subscriber units 146 when they are under the coverage of network B and to dynamically include them in individual and group calls with no loss of features (including PTT and trunking). It also gives network B control of visiting LMR subscriber units 146 based on inter-agency agreements.

The ISSI architecture is based on the concept of a “home” and a “serving” RFSS 144. The home RFSS 144 represents the normal location and radio coverage area under which a particular LMR subscriber unit 146 and their group operate. A serving RFSS 144 represents a foreign location and radio coverage area to which the LMR subscriber unit 146 has roamed. A general principle of ISSI is to be “home oriented,” which means that any decision regarding LMR subscriber units 146, groups and calls is taken by the home RFSS 144.

Mobility management procedures in ISSI allow an LMR subscriber unit 146 to access services outside of its home RFSS 144. In addition, these procedures allow a group to be expanded outside of its home RFSS 144. An LMR subscriber unit 146 moving outside its home RFSS 144 radio coverage will be able to register with the group it is interested in when within the radio coverage of the serving RFSS 144 (assuming compatible radio frequencies), according to a mutual agreement between networks.

The serving RFSS 144 to which the LMR subscriber unit 146 has roamed has the responsibility to inform the home RFSS 144 of the new location of the LMR subscriber unit 146. The home RFSS 144 of the LMR subscriber unit 146 updates their databases, so that the networks know where the LMR subscriber unit 146 is located when there is a need to connect a call to the LMR subscriber unit 146.

Call control procedures define unit-to-unit calls and group calls using the RFSS's 144. A unit-to-unit call can be set-up dynamically between any two LMR subscriber units 146 that can be each located at their home RFSS 144 or at any serving RFSS 144. The unit-to-unit call is managed by the home RFSS 144 of the calling party and will involve the home RFSS 144 of the called party and the serving RFSS's 144 where each LMR subscriber unit 146 is registered.

A group call can be set-up over several RFSS's 144, based on the registrations to that group that have been requested by any serving RFSS 144, and using Mobility Management procedures. Following the “home oriented” principle of the ISSI, the group call is handled by the home RFSS 144 of the group.

The call control procedures rely mainly on SIP methods for session initiation (SIP INVITE) and termination (SIP BYE). The associated RTP session to support the voice media flows is negotiated, set up and torn down together with the SIP session.

PIT management procedures allow for the control of the RTP voice media transmission between the RFSS's 144 involved in a voice call. The PIT management procedures, including state behaviors and arbitration rules, are applied by a Master Media Function (MMF) and Subordinate Media Function (SMF). The main control functions include:
Request by a serving RFSS 144 for permission to transmit an RTP voice payload;
Queuing, granting or denying by a home RFSS 144 of permission to transmit;
Initiation by a home RFSS 144 of an outbound RTP voice payload;
Termination of PTT transmission from a given RFSS 144;
Muting of undesired audio by a home or serving RFSS 144.

For a group call, the MMF is located at the home RFSS 144 of the group and the SMFs are located at the serving RFSS's 144. For a unit-to-unit call, the MMF is located at the home RFSS 144 of the called party and the SMFs are located at the serving RFSS's 144.

### 5.4 Interoperability Models

The present invention provides several interoperability models for the PoC system 100 and LMR system 142.

5.4.1 The PoC System as an Independent WACN

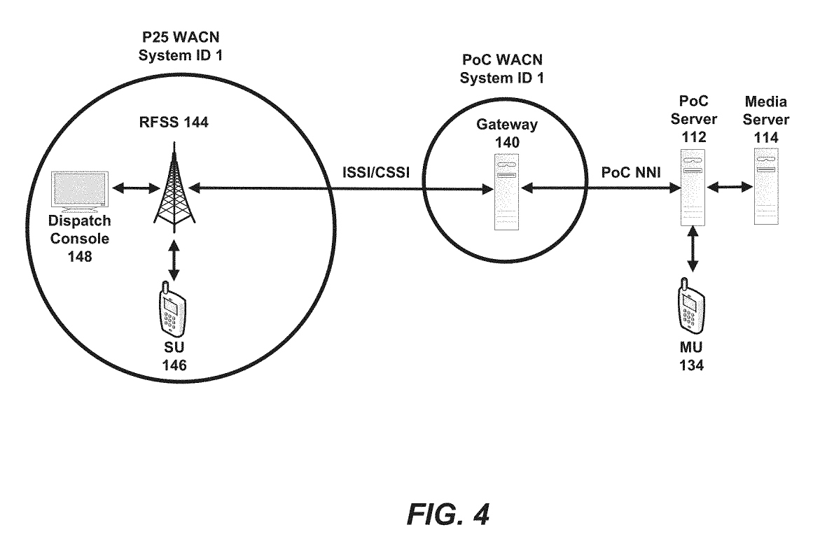

In a first model as shown in FIG. 4, the Gateway 140 emulates an LMR system (identified as “System ID 1”) in an independent WACN (identified as “PoC WACN”). The actual LMR system 142 (identified as “System ID 1”) is in a different WACN (identified as “P25 WACN”). Specifically, the Gateway 140 exposes the PoC system 100 to the LMR system 142 as a separate peer WACN. The PoC mobile units 134, LMR subscriber units 146, and their groups, can span both the PoC WACN and P25 WACN. For example, calls can be placed across the PoC WACN and P25 WACN to both PoC mobile units 134 and LMR subscriber units 146.

5.4.2 Subscribers in the LMR System as Subscribers in the PoC WACN

In a second model, which is also shown in FIG. 4, one or more of the LMR subscriber units 146 operating in the P25 WACN are configured as being “homed” in the PoC WACN. Specifically, one or more of the LMR subscriber units 146 in the P25 WACN are considered to be visiting the P25 WACN, wherein the RFSS 144 in the P25 WACN registers with the PoC WACN as a serving RFSS 144 for the LMR subscriber units 146 homed in the PoC WACN. These LMR subscriber units 146 homed in the PoC WACN are exposed to the PoC system 100 using pseudo-MDNs.

5.4.3 RFSS in the PoC System as Part of the LMR WACN

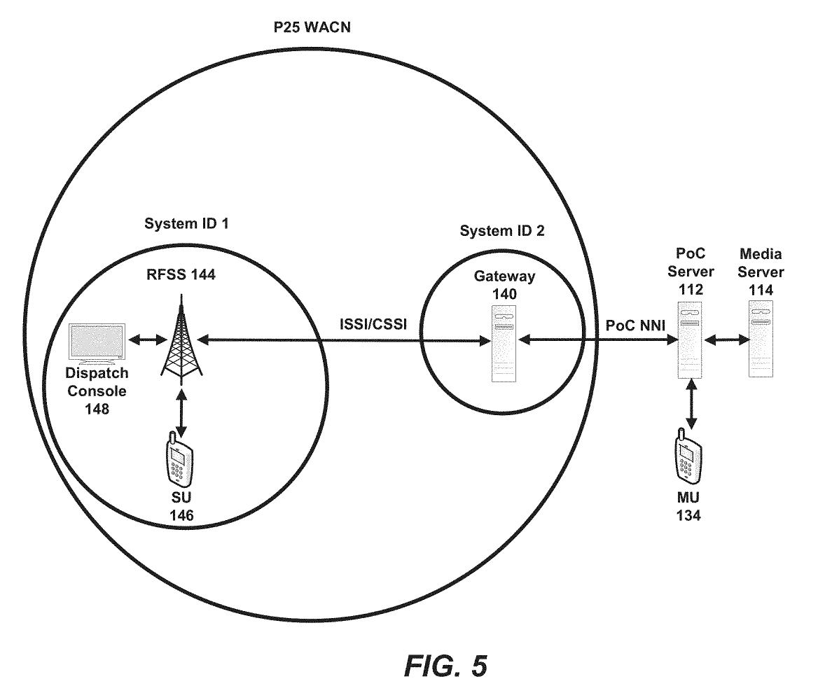

In a third model as shown in FIG. 5, the Gateway 140 emulates an LMR system (identified as “System ID 2”) in the same WACN (identified as “P25 WACN”) as the actual LMR system 142 (identified as “System ID 1”). Specifically, the Gateway 140 emulates a serving RFSS belonging to the same P25 WACN. One or more of the PoC mobile units 134 in the PoC system 100 are assigned pseudo-SU-IDs for the P25 WACN and are homed in one of the RFSS's 144 in the P25 WACN. These PoC mobile units 134 are considered to be visiting the Gateway 140 in the PoC system 100, and the Gateway 140 registers as the serving RFSS for the pseudo-SU-IDs and pseudo-SG-IDs assigned to these PoC mobile units 134.

5.4.4 Gateway Interoperability

The Gateway 140 not only handles 1-to-1 calls and group calls between the PoC system 100 and the LMR system 142 by means of a Gateway (GW) function, but also provides Gateway Management Server (GWMS) and Gateway Registrar (GR) functions.

The Gateway function performs the following:
Emulates an RFSS 144 in a LMR system 142, and uses ISSI/CSSI with peer LMR systems 142 to enable PoC system 100 subscribers and groups to interact with LMR system 142 subscribers and groups.
Uses PoC NNI for call signaling with the PoC Server 112, which is based on SIP protocol in one of the embodiments.
Performs media trans-coding between different codecs.
Uses the data provisioned in the Gateway Management Server function for routing and authorizing the calls passing through the Gateway 140.

The Gateway Management Server function performs the following:
Provides a provisioning interface for configuring peer RFSS details.
Maps the RFSS ID (WACN+System ID+RFSS ID) to an IP address and opens a VPN tunnel to that IP address.
Interfaces to setup Interoperability Accounts through which contacts and groups are shared across the PoC system 100 and LMR system 142.
Assigns and maintains mappings for PoC system 100 subscribers and groups that are exported to the LMR system 142, and the LMR system 142 subscribers and groups that are exported to the PoC system 100.

The Gateway Registrar function performs the following:
Maintains list of serving RFSS's 144 that are registered for PoC groups exported to the LMR system 142.
Registers for receiving group calls for groups from the LMR system 142 that are exported to the PoC system 100.

5.4.5 Gateway Interfaces

The Gateway function provides interfaces between the PoC system 100 and LMR system 142. As noted above, ISSI and CSSI protocols are used by the Gateway function for 1-1 and group voice calls with peer LMR systems 142.

The PoC NNI is used between the Gateway function and the PoC Server 112 for 1-1 and group voice calls involving LMR system 142 subscribers and groups. The Gateway function bridges between the PoC NNI and ISSI/CSSI protocols.

5.4.6 Gateway Management Interfaces

The Gateway Management function provides for system and Corporate Administrators, as well as the XDM Server 108, the Gateway Registrar function, and the Gateway function.

A System Administrator accesses the Gateway Management Server function to:
Provision the LMR systems 142, and manage both VPN and IP interfaces with these peer LMR systems 142.
Create Interoperability Accounts and set up policy rules, such as size limits for subscriber and group import/export lists, call authorization policies, etc.
All functions available to System Administrators on the PoC system 100 are also available to System Administrators on the LMR system 142, and all functions available to System Administrators on the LMR system 142 are also available to System Administrators on the PoC system 100.

A Corporate Administrator accesses the Gateway Management Server function to:
Import and export subscribers and groups of the LMR system 142.
Import and export subscribers and groups of the PoC system 100.

The XDM Server 108 accesses the Gateway Management Server function to exchange information about imported/exported subscribers and groups in order to update databases on both the PoC system 100 and LMR system 142.

The Gateway Registrar function accesses the Gateway Management Server function to provide notifications when subscribers and/or groups are imported and/or exported. The Gateway Registrar function uses this information to initiate and/or terminate registration related dialogs.

The Gateway function also accesses the Gateway Management Server function to query for routing configurations and subscriber/group ID mappings.

5.4.7 Gateway Registrar Interfaces

The Gateway Registrar function provides an interface for the Gateway function for managing SIP registrations as part of ISSI mobility management functions. This information is used by the Gateway function for receiving and/or originating call segments for group calls involving the LMR system 142.

5.4.8 PoC Corporate Administration Tool (CAT) Interfaces

The Corporate Administration Tool (CAT) of the WGP Server 122 is used by Corporate Administrators to manage contacts and groups of corporate subscribers. The CAT has a Web User Interface for Corporate Administrators that supports the following operations:
Add LMR system 142 subscribers and groups to external contacts lists, so that LMR system 142 subscribers can be shared with PoC system 100 subscribers as contacts and group members.
Associate LMR system 142 groups with PoC system 100 groups, and share such associations with PoC Clients 136.

5.4.9 PoC XCAP Interface

The PoC system 100 provides an XCAP interface between PoC Clients 136 and the XDM Server 108 enables the PoC Clients 136 to present LMR system 142 subscribers and groups to users on the PoC mobile units 134.

5.5 Data Management for Interworking the PoC System to the LMR System

Identity mappings to make the subscriber and groups of the respective systems routable to each other are configured through the management interfaces. In order to make the external subscribers and groups from peer LMR systems 142 addressable to the PoC system 100 users, it is necessary to map these SU-IDs and SG-IDs to pseudo-MDNs on the PoC system 100. Pseudo-MDN pools, also known as the PoC NNI MDN pools, are first provisioned and then these pseudo-MDNs are mapped to actual LMR system 142 subscribers and groups.

An NNI Data Management function of the Gateway 140 includes the following:

1. PoC NNI Account Management (PAM).

2. Corporate Data Management (contact and group management).

5.5.1 PoC Gateway Account

A PoC Gateway Account enables a corporate account to use PoC service with contacts and groups spanning multiple heterogeneous PoC/LMR systems. The PoC Gateway Account must be created through the provisioning system and the PoC corporate account instances on various PoC systems 100 should be linked to the PoC Gateway Account. The PoC Gateway Account may be linked to corporate accounts from more than one PoC system 100.

Once a PoC system 100 corporate account is linked to a PoC Gateway Account, pseudo-MDNs provisioned on that corporate account can be mapped to external subscribers and groups through the Gateway 140.

5.5.1.1 PoC NNI MDN

In order to make non-PoC subscribers and groups addressable to the PoC system 100 users, one or more pseudo-MDN pools must be specifically provisioned for each corporate account. The pseudo-MDNs in this pool are then mapped to specific types of external subscribers and groups by the Gateway 140. A pseudo-MDN that is used for mapping to external subscribers and groups in this manner are referred to as a “PoC NNI MDN”. Further, a pseudo-MDN that is associated with an external subscriber is referred to as a “PoC NNI Alias MDN” and a pseudo-MDN associated with an external group is referred to as a “PoC NNI Group MDN”.

The PoC NNI MDNs are typically provisioned as PoC pseudo-MDN pools through the PAM and they appear as part of the corporate account master list on the CAT. A Corporate Administrator using the CAT can perform the following operations with PoC NNI MDNs:

1. Assign the PoC NNI Alias MDNs as contacts and groups members.

2. Add PoC NNI Group MDN into one and only one PoC group.

The PoC pseudo-MDN pools created though the provisioning system are identified by specific types. The pseudo-MDN type governs the data management operations permitted for that pseudo-MDN. For example, the following two types of pseudo-MDNs are required for supporting the PoC NNI with the LMR system 142. The PoC NNI MDN pools used for inter-operability with the LMR system 142 should be provisioned through PAM with these client types.

1. LMR Subscriber Unit (SU). The LMR Subscriber Unit client type is used for making external LMR subscribers addressable to the PoC system 100 users. Typically, a pool of LMR SU type subscribers shall be provisioned through PAM and each MDN in this pseudo-MDN pool will be mapped to an actual LMR Subscriber Unit on the Gateway 140.

2. LMR Subscriber Group (SG). An LMR Subscriber Group MDN is similar to the existing PoC Donor Radio (inter-operability) client type. It is used for linking PoC groups with external LMR Groups in order to facilitate creation of groups spanning both the PoC system 100 and the LMR system 142. An LMR Subscriber Group MDN is added to the PoC Group as a group member and it is mapped to a LMR Group on the Gateway 140. Typically, a pool of LMR SG type subscribers shall be provisioned through PAM and each MDN in this pseudo-MDN pool will be mapped in this manner to a LMR Group.

5.5.2 User Roles in the Interworking of the PoC System to the LMR System

5.5.2.1 Gateway System Administrator Role

A Gateway Account is created and managed through a Gateway System

Administrator interface. The Gateway System Administrator interface configures the following as part of the account:
Associate the Gateway Account with a PoC Corporate ID.
Specify the list of RFSS's 144 in the LMR systems 142 with which the subscribers belonging to the corporation are allowed to communicate.
Set size limits for import/export lists for subscribers and groups.

The System Administrator may optionally use the functions available to a Corporate Administrator on the PoC system 100 to export and/or import contacts and groups across the systems 100, 142.

5.5.2.2 Corporate Administrator Role

A Corporate Administrator on the PoC system 100 uses the Gateway Management function to perform the following:
Import LMR system 142 subscribers and groups into the PoC system 100.
Export PoC system 100 subscribers and groups to the LMR system 142.
Add the imported LMR system 142 subscribers to external corporate contact lists and share them as contacts and groups members to PoC system 100 subscribers.
Add PoC system 100 subscribers as group members to imported LMR system 142 groups to enable them to participate in LMR system 142 group calls.

5.5.2.3 PoC Subscriber Role

Each PoC Client 136 presents LMR system 142 contact and group details to the user on the PoC mobile unit 134, and the user can make and/or receive calls using these LMR system 142 contacts and groups.

5.5.3 Identity Mapping

5.5.3.1 Setting Up the WACN for the PoC System

As noted above, the Gateway function exposes the PoC system 100 with a WACN ID to LMR systems 142 that support ISSI/CSSI. The Gateway function can be setup to serve multiple PoC systems 100, which may include the following:
Multiple PoC systems 100 of the same carrier.
Multiple PoC systems 100 belonging to different carriers.

The WACN ID assigned to the PoC system 100 may be mapped to “Carrier ID+Instance Number” or it may be assigned the same WACN ID as the LMR system 142.

5.5.3.2 Provisioning LMR IDs for the PoC System

Due to the P25 numbering scheme related restrictions, each LMR system 142 can serve up to 16M SU-IDs and up to 64K SG-IDs. Hence, depending on number of PoC groups exported to external LMR systems 142, one or more System-IDs need to be added under each WACN-ID. When a System-ID is added to PoC system 100, it is associated with a new emulated PoC Server 112 instance in the PoC system 100. The emulated PoC Server 112 that is associated with the System-ID is a logical function and need not have a physical manifestation.

5.5.3.3 Assigning RFSS IDs to the PoC System

Each System-ID is normally associated with one or more RFSS's 144 and/or Dispatch Consoles 148. However, in case of a System-ID under a PoC system 100, one and only one RFSS 144 is required. A fully qualified identifier for the RFSS 144 is of the form RFSS-ID.System-ID.WACN-ID. Therefore, an RFSS-ID is assigned to the PoC system wo as described below:
RFSS-ID=hardcoded to “01” since there is only one instance of an RFSS 144 (emulated by the Gateway 140) for each System-ID associate with a PoC system 100.
System-ID=an ID associated with the PoC Server 112 of the PoC system 100 connected with the LMR system 142.
WACN-ID=as provisioned in the Gateway function by a System Administrator.

Network interface details (such as an IP address, VPN details, etc.) are configured for each RFSS 144 in the PoC system 100. For example, the same IP interface may be used for multiple RFSS's 144 in the PoC system 100. External LMR systems 142 can reach the PoC system 100 through this interface.

5.5.3.4 Exporting PoC Subscribers and Groups to the LMR System

The following explains the mappings required to expose the PoC system wo as an emulated LMR system 142. This allows the PoC subscribers and groups to be visible from the LMR system 142.

5.5.3.4.1 Setup Gateway Account

In order to export PoC system 100 subscribers and groups to the LMR system 142, it is necessary to set up a Gateway Account and associate it with a corporate account. The Gateway Account is homed in an RFSS 144 under one of the PoC systems 100.

5.5.3.4.2 Export PoC Subscribers to the LMR System

Adding a PoC subscriber to the Gateway Account exposes the subscriber to the LMR system 142. A pseudo-SU-ID is assigned to that subscriber. The pseudo-SU-ID assigned to the subscriber is of the form “<WACN-ID><System-ID><Unit-ID>, where:
WACN-ID=as provisioned in the Gateway function by the System Administrator.
System-ID=an ID associated with the PoC Server 112 of the PoC system 100 connected with the LMR system 142.
Unit-ID=6 hex-digit ID, unique with the scope of the RFSS 144 of the PoC system 100.

The SU-ID of the PoC subscriber is considered homed in the RFSS 144 of the PoC system 100. A SIP URI for the PoC subscriber is of the form “SIP: <Assigned-SU-ID>@p25dr;user=TJA-P25-SU”.

5.5.3.4.3 Export PoC Groups to the LMR System

Adding a PoC group to the Gateway Account exposes the group to the LMR system 142. The Corporate Administrator can add LMR subscribers as group members to PoC groups that are exported through the Gateway function. A pseudo-SG-ID is assigned to the PoC Group.

The pseudo-SG-ID assigned to the PoC Group is of the form “<WACN-ID><System-ID><Group-ID>, where
WACN-ID=as provisioned in Gateway function by the System Administrator.
System-ID=an ID associated with the PoC Server 112 of the PoC system 100 connected with the LMR system 142.
Unit-ID=4 hex-digit ID, unique with the scope of the RFSS 144 of the PoC system 100.

The SG-ID of the PoC group is considered homed in the RFSS 144 of the PoC system 100. A SIP URI for the PoC subscriber is of the form “SIP: <Assigned-SG-ID>@p25dr;user=TJA-P25-SG”.

5.5.3.5 Importing LMR Subscribers and Groups

The following explains the mappings required to expose the LMR system 142 as an emulated PoC system 100. This allows the LMR subscribers and groups to be visible from to the PoC system 100.

5.5.3.5.1 Adding the RFSS to the Gateway Account

In order to import external LMR subscribers and groups, the RFSS 144 of the LMR system 142 must first be added to the Gateway Account. An RFSS 144 may be added to multiple Gateway Accounts.

5.5.3.5.2 Importing LMR Subscribers

An LMR subscriber is imported into the PoC system 100 by adding the SU-ID of the LMR subscriber into a Gateway Account. The LMR subscriber is assigned a pseudo-MDN when added to the Gateway Account. A different pseudo-MDN is assigned to the LMR subscriber in each account when it is added to multiple accounts.

The Corporate Administrator may perform the following:
Add imported LMR subscribers to an external corporate contact list.
Share the imported LMR subscribers with PoC subscribers as part of contact lists and as group members.

5.5.3.5.3 Importing LMR Groups

An LMR group is imported into the PoC system 100 by adding the SG-ID of the LMR group into a Gateway Account. The LMR group is assigned a pseudo-Group URI when it added to the Gateway Account. A different pseudo-Group URI is assigned to the LMR group in each account when it is added to multiple accounts.

The Corporate Administrator may perform the following:
Add PoC subscribers to the external LMR group and distribute it to PoC subscribers.

5.5.4 Configuring the RFSS Interface in the Gateway Function

5.5.4.1 Adding the LMR System to the Gateway Function

In order to enable communication between the PoC system 100 and the LMR system 142, the LMR system 142 must be provisioned in the Gateway function.

5.5.4.2 SIP Routing Policy for the LMR System

5.5.4.2.1 LMR System Level Routing

The “WACN-ID+System-ID” is mapped to the IP interface for routing SIP messages towards the LMR system 142. This is an optimal configuration and can be used when there is only one RFSS 144 in the LMR system 142, or where there is an ingress SIP Gateway in the LMR system 142 that handles the routing based on subscriber/group SIP URIs.

5.5.4.2.2 RFSS Level Routing

The “WACN-ID+System-ID+RFSS-ID” is mapped to the IP interface for routing SIP messages towards a specific RFSS 144 in the LMR system 142. This requires the Gateway function to look up LMR subscribers for their mapping from SIP URI to the RFSS 144 in the LMR system 142, in order to identify the destination RFSS 144.

5.6 Call Flows

5.6.1 User Identity Mapping

Once the ID mappings and configuration described the previous sections is accomplished through the administrator functions, PoC subscribers and LMR subscribers can communicate with each other using one of the methods described below:

Method 1:
A PoC subscriber can use a PoC Client 136 to call LMR subscriber units 146, as well as Dispatch Consoles 148, by dialing the corresponding Pseudo-MDN associated with the LMR subscriber unit 146 or Dispatch Console 148. When receiving the call, the LMR subscriber unit 146 or the Dispatch Console 148 will perceive the calling party identity as the Pseudo-SU-ID that is associated with the PoC Client 136.
An LMR subscriber unit 146 or Dispatch Console 148 can call a PoC Client 136 by dialing the Pseudo-SU-ID associated with the PoC Client 136. When receiving the call, the PoC Client 136 will perceive the calling party identity as the Pseudo-MDN that is associated with the LMR subscriber unit 146 or Dispatch Console 148.

Method 2:
A PoC subscriber can use a PoC Client 136 to call LMR subscriber units 146, as well as Dispatch Consoles 148, by dialing the SU-ID of the LMR subscriber unit 146 or Dispatch Console 148. When receiving the call, the LMR subscriber unit 146 or the Dispatch Console 148 will perceive the calling party identity as the Pseudo-SU-ID that is associated with the PoC Client 136.
An LMR subscriber unit 146 or Dispatch Console 148 can call a PoC Client 136 by dialing the Pseudo-SU-ID associated with the PoC Client 136. When receiving the call, the PoC Client 136 will perceive the calling party identity as the SU-ID of the LMR subscriber unit 146 or the Dispatch Console 148.

50.6.2 Unit-To-Unit Call

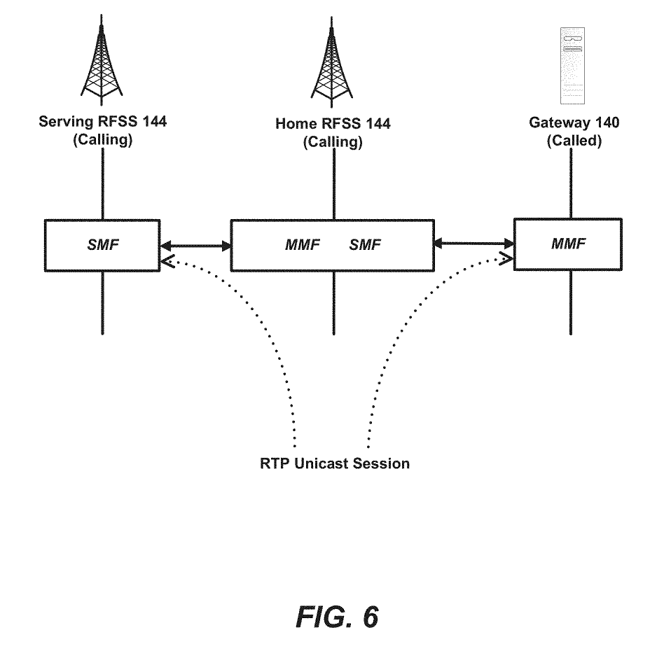

In conventional OMA-standards-based PoC systems, the originating PoC Server 112 performs the role of controlling PoC in a unit-to-unit call. However, in order to interwork with the LMR System 142, the terminating PoC Server 112 is modified to act as a Master Media Function (MMF) and take the role of Controlling PoC Function during a unit-to-unit call between a PoC mobile unit 134 and an LMR subscriber unit 146. FIG. 6 illustrates the MMF and Subordinate Media Function (SMF) participation during an unit-to-unit call where the PoC Server 112 is acting as an MMF

5.6.2.1 Calls from the LMR System to PoC System

In the case where the unit-to-unit call is originated in the LMR system 142, the PoC Server 112 takes a role of a controlling function. The Gateway 140 translates the message to a corresponding mapped SIP message towards the PoC system 100, and fills in the necessary information required for the PoC system 100. The Gateway 140 acts as a back-to-back user agent (B2BUA) for a call between the two systems 100, 142, and maintains two different dialogs from each system 100, 142. A LMR subscriber unit 146 in the LMR system 142 calls an SU-ID that is mapped to an MDN for the PoC mobile unit 134 in the Gateway 140, and the request is forwarded to the appropriate PoC system wo for further processing of the call.

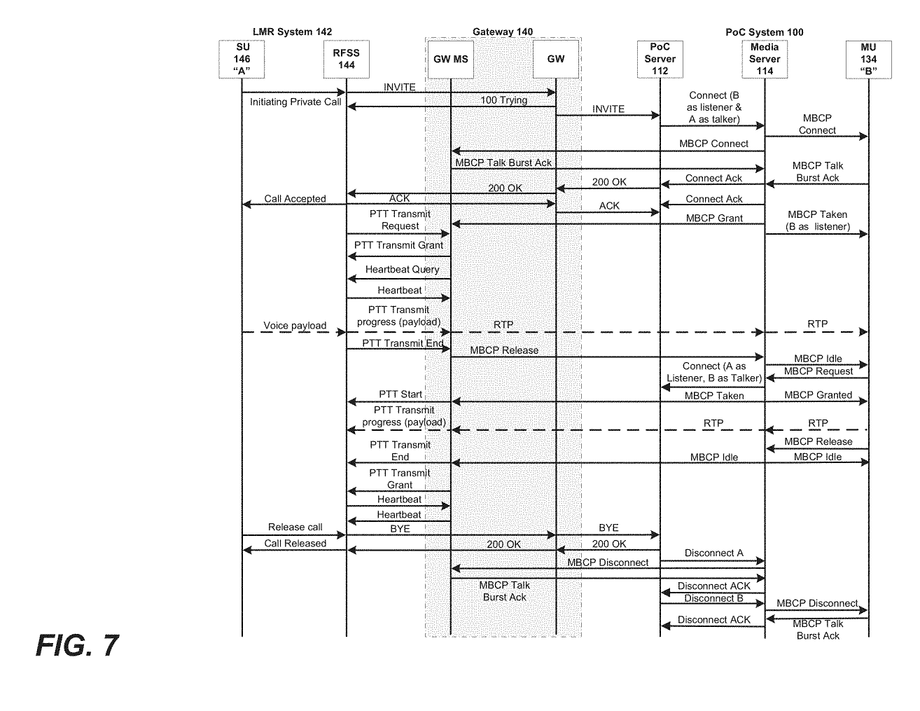

FIG. 7 further describes the call flow in this scenario.

1. The Gateway 140 translates INVITE, 200 OK and ACK messages between the LMR system 142 and the PoC system wo to establish a PIT session.

2. The PoC server 112 decides who would be the initial talker as part of 200 OK response and distributes the MBCP Taken and Granted messages to the PoC users and the Gateway 140.

3. Floor control messages from the LMR system 142 use the RTP protocol, but floor control messages from the PoC system wo use RTCP messages, which requires the Gateway 140 to convert floor control RTP messages into their respective RTCP messages, and vice versa as below:

(a) a PIT Transmit Request is mapped to an MBCP Request,

(b) a PIT Transmit End is mapped to an MBCP Release,

(c) an MBCP Granted is mapped to a PTT Transmit Grant,

(d) an MBCP Deny is mapped to a PIT Deny, and

(e) an MBCP Taken is mapped to a PIT Start.

4. Upon receiving a “PTT Transmit Request” from the LMR system 142, the Gateway 140 responds back with a “PTT Transmit Grant” to the LMR system 142, in the case where the Gateway 140 finds that the PIT floor has already been granted to the LMR subscriber unit 146.

5. The Gateway 140 sends a Heartbeat Query message periodically to the LMR system 142 and handles the Heartbeat response from the LMR system 142.

6. Upon receiving a “PTT Transmit Progress” from the LMR system 142 while the floor is taken by an LMR subscriber unit 146, the Gateway 140 extracts the voice payload from this message and transmits this voice payload towards the PoC system wo by encapsulating it in RTP messages.

7. Upon receiving a “PIT Transmit End” from the LMR system 142, the Gateway 140 translates the message to a “MBCP Release” for the PoC system 100. Before sending or after receiving “PTT Transmit End,” all of the buffered media frames have to be delivered to the peer network.

8. If any PoC user takes the floor, then on receiving a “MBCP Taken” from the PoC system 100, the Gateway 140 translates the message to a “PTT Start” for the LMR system 142.

9. Upon receiving a RTP voice packets from the PoC system 100, the Gateway 140 translates it to a “PTT Transmit Progress” message for the LMR system 142, where the floor is taken by a PoC subscriber.

10. Any unstoppable media from the LMR system 142 is handled by the Gateway 140 and is given as a higher priority than the PoC user.

11. Either the PoC system 100 or the LMR system 142 can send a BYE message to terminate the session.

5.6.2.2 Calls from the PoC System to the LMR System

In the case where the unit-to-unit call is originated in the PoC system 100, the Gateway 140 translates the messages to their corresponding mapped SIP messages for the LMR system 142 and fills in the necessary information required. An SU-ID is mapped to an MDN in the Gateway 14o. During a call from the PoC system 100, the MDN is converted to the SU-ID and the request is forwarded to the appropriate LMR system 142 for further processing of the call.

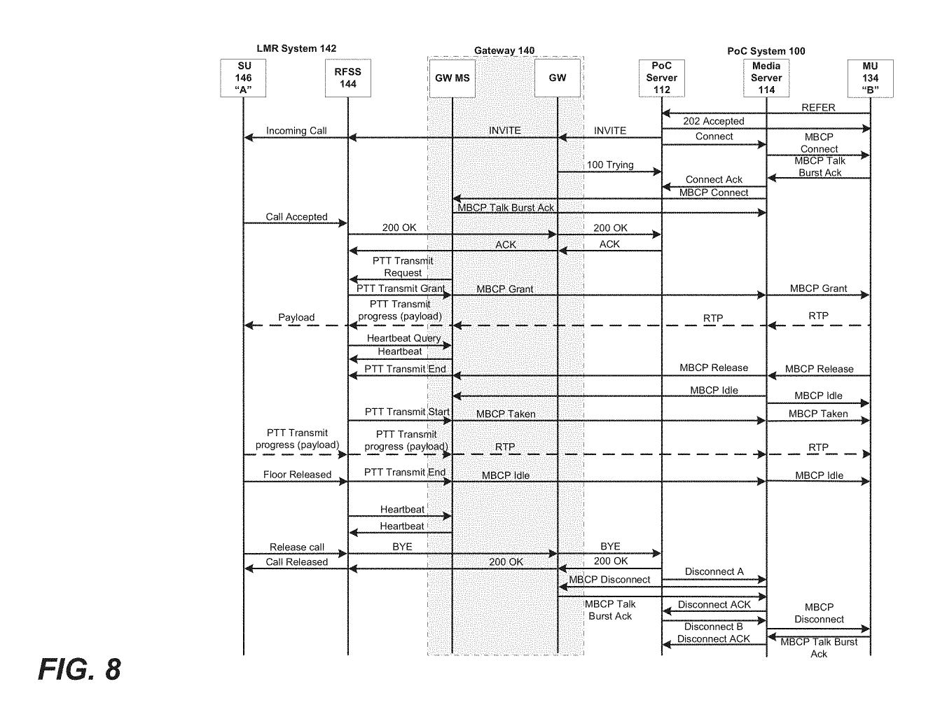

FIG. 8 further describes the call flow in this scenario.

1. The Gateway 140 translates INVITE, 200 OK and ACK messages between the PoC system 100 and the LMR system 142 to establish a PTT session.

2. The PoC server 112 decides who would be the initial talker after receiving a 200 OK response and distributes the MBCP Taken and Granted messages to the PoC mobile units 134 accordingly.

3. Floor control messages from the LMR system 142 use the RTP protocol, but floor control messages from the PoC system 100 use RTCP messages, which requires the Gateway 140 to convert floor control RTP messages into their respective RTCP messages, and vice versa as below:

(a) a PIT Transmit Request is mapped to an MBCP Request,

(b) a PIT Transmit End is mapped to an MBCP Release,

(c) an MBCP Granted is mapped to a PTT Transmit Grant,

(d) an MBCP Deny is mapped to a PIT Deny, and

(e) an MBCP Taken is mapped to a PIT Start.

4. The Gateway 140 sends a “PTT Transmit Request” to the LMR system 142 and the LMR system 142 responds back with an appropriate message, such as “PTT Transmit Grant” or “PTT Deny”.

5. The Gateway 140 receives a Heartbeat Query message periodically from the LMR system 142 and handles the Heartbeat response to the LMR system 142.

6. Upon receiving RTP packets with payloads from the PoC system 100, the Gateway 140 translates these RTP packets to “PTT Transmit Progress” messages to the LMR system 142.

7. Upon receiving an “MBCP Release” from the PoC system 100, the Gateway 140 translates this message to a “PTT Transmit End” for the LMR system 142.

8. If any PoC user takes the floor, then upon receiving a “MBCP Taken” message from the PoC system 100, the Gateway 140 translates the message to a “PTT Start” for the LMR system 142.

9. Similarly, if any LMR subscriber unit 146 takes the floor, the LMR system 142 transmits the audio packets to the Gateway 140 to send to the PoC system 100

10. Any unstoppable media from the LMR system 142 is handled by the Gateway 140 and is given a higher priority than the PoC user.

11. Either system 100, 142 can send a BYE message to terminate the session.

5.6.3 Group Call

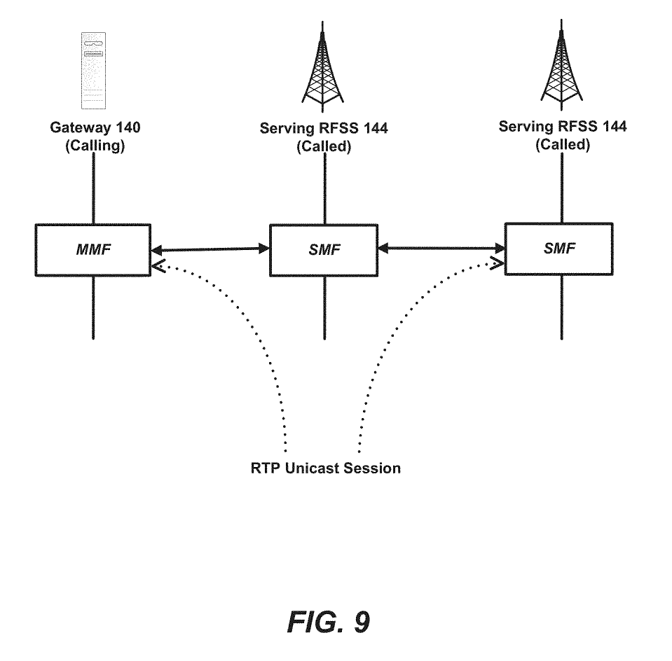

In a group call setup, the RFSS 144 where the group is hosted always acts as an MMF. If the group is hosted in the PoC network 100, then the PoC Server 112 performs a controlling function. FIG. 9 illustrates MMF and SMF participation during a group call, where the group is hosted in the PoC system 100

5.6.3.1 Group Call from the LMR System to the PoC System

In the case of a group call originated in the LMR system 142, the serving RFSS 144 in the LMR system 142 extends a call leg towards the Gateway 14o, where an SG-ID is mapped to an SG-MDN, which is an addressable identity in the PoC system 100. The SG-MDN is an MDN created in the PoC system 100, which is unique in the PoC system 100, and is added as a member to a PoC group.

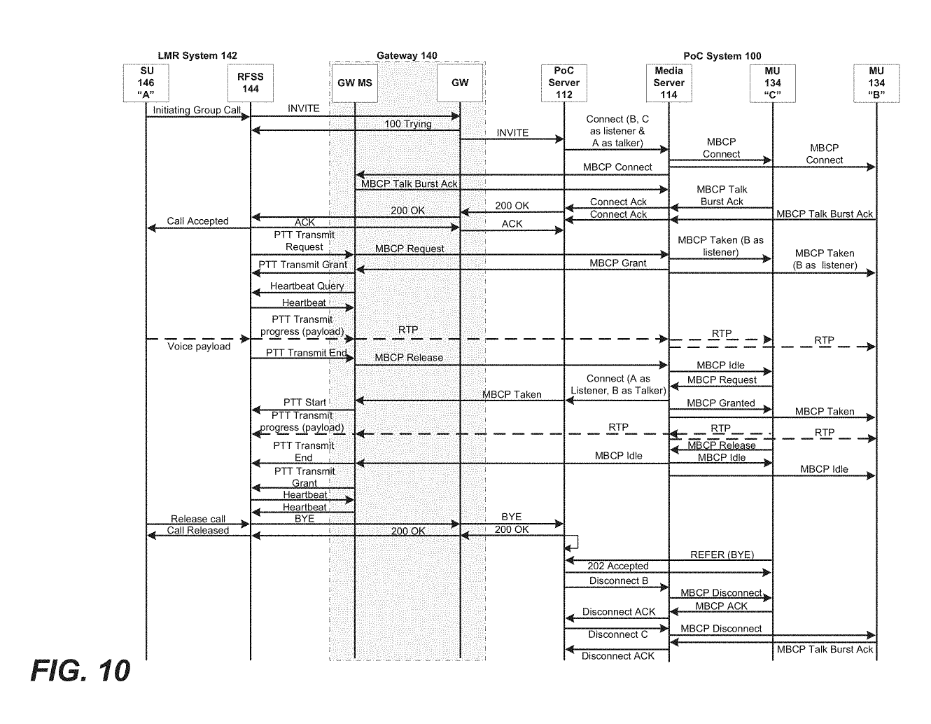

FIG. 10 further describes the call flow in this scenario.

1. The Gateway 140 translates INVITE, 200 OK and ACK messages between the PoC system 100 and the LMR system 142 to establish a PIT session.

2. The PoC server 112 decides who would be the initial talker after receiving a 200 OK response and distributes the MBCP Taken and Granted messages to the PoC mobile units 134 accordingly.

3. Floor control messages from the LMR system 142 use the RTP protocol, but floor control messages from the PoC system wo use RTCP messages, which requires the Gateway 140 to convert floor control RTP messages into their respective RTCP messages, and vice versa.

4. Upon receiving a “PTT Transmit Request” from the LMR system 142, the Gateway 140 responds back with a “PTT Transmit Grant” to the LMR system 142.

5. The Gateway 140 starts a Heartbeat Query message periodically to LMR system 142 and handles the Heartbeat response from the LMR system 142.

6. Upon receiving a “PTT Transmit Progress” from the LMR system 142 while floor is taken by an LMR subscriber unit 146, the Gateway 140 sends RTP messages with voice message payloads towards the PoC system 100.

7. Upon receiving a “PIT Transmit End” from the LMR system 142, the Gateway 140 translates the message to a “MBCP Release” towards the PoC system 100.

8. If any PoC user takes the floor, then on receiving a “MBCP Taken” from the PoC system 100, the Gateway 140 translates the message to a “PTT Start” towards the LMR system 142.

9. Upon receiving RTP voice packets from the PoC system 100, the Gateway 140 translates them into “PTT Transmit Progress” messages towards the LMR system 142, when the floor is taken by a PoC subscriber.

10. Any unstoppable media from the LMR system 142 is handled by the Gateway 140 and is given a higher priority than the PoC user. Unstoppable media comprises RTP voice packets received from the LMR system 142 without it sending a “PTT Transmit Start.” If a PoC subscriber has the floor, then the unstoppable media is considered to be an implicit floor revoke.

11. Either system 100, 142 can send a BYE message to terminate the session. However, the PoC Server 112 does not terminate the call unit unless there is only one participant remaining.

5.6.3.2 Group Call from the PoC System to the LMR System

In the case of a group call originated in the PoC system 100, the Gateway 140 translates the message to corresponding mapped SIP messages towards the LMR system 142 and fills in the necessary information required. An SG-ID is mapped to an SG-MDN on the Gateway 14o. During a call from the PoC system 100, the SG-MDN is converted to an SG-ID in the LMR system 142, and the request is forwarded to the appropriate LMR system 142 for further processing of the call.

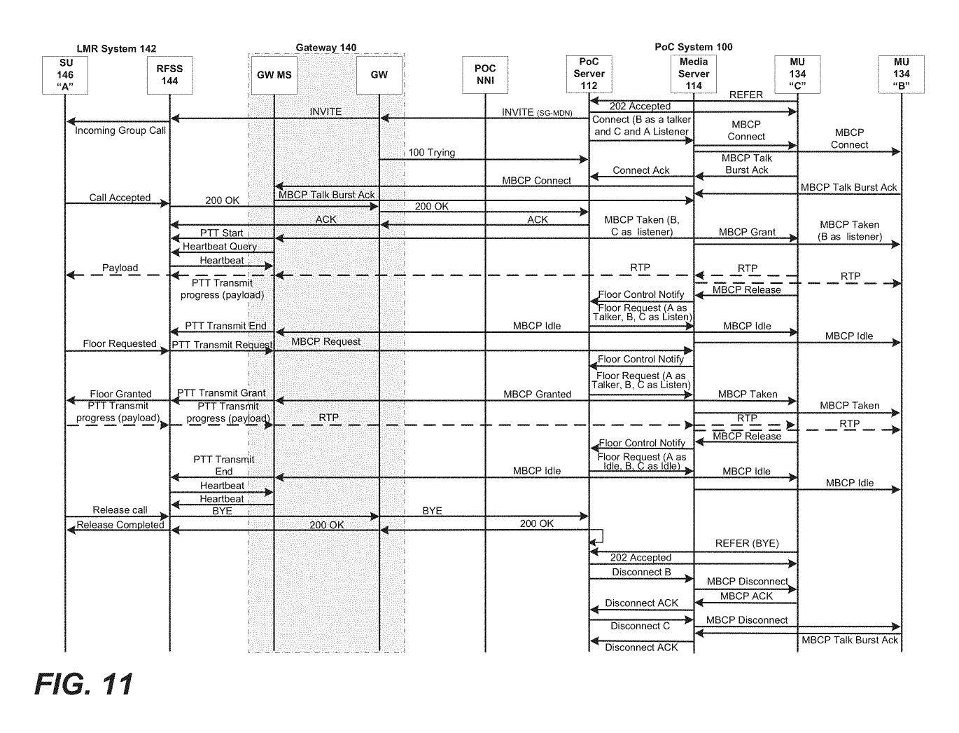

FIG. 11 further describes the call flow in this scenario.

1. The Gateway 140 translates INVITE, 200 OK and ACK messages between the PoC system 100 and the LMR system 142 to establish a PIT session.

2. The PoC server 112 decides who would be the initial talker after receiving a 200 OK response and distributes the MBCP Taken and Granted messages to the PoC mobile units 134 accordingly.

3. Floor control messages from the LMR system 142 use the RTP protocol, but floor control messages from the PoC system 100 use RTCP messages, which requires the Gateway 140 to convert floor control RTP messages into their respective RTCP messages, and vice versa.

4. The Gateway 140 sends a “Transmit Start” after receiving a “MBCP Taken” from the PoC system 100 when PoC user takes the floor.

5. The Gateway 140 starts a Heartbeat Query message periodically to LMR system 142 and handles the Heartbeat response from the LMR system 142.

6. Upon receiving RTP voice packets from the PoC system 100, the Gateway 140 translates them into “PTT Transmit Progress” messages towards the LMR system 142, when the floor is taken by a PoC subscriber.

7. Upon receiving a “PIT Idle” from the PoC system 100, the Gateway 140 translate the message to a “PIT Transmit End” towards the LMR system 142.

8. Upon receiving a “PIT Transmit Request” from the LMR system 142, the Gateway 140 responds back with a “PTT Transmit Grant” or “PTT Deny” to the LMR system 142, and then media flows from the LMR system 142 to the PoC system 100.

9. Any unstoppable media from the LMR system 142 is handled by the Gateway 140 and is given a higher priority than the PoC user. Unstoppable media comprises RTP voice packets received from the LMR system 142 without it sending a “PTT Transmit Start.” If a PoC subscriber has the floor, then the unstoppable media is considered to be an implicit floor revoke.

11. Either system 100, 142 can send a BYE message to terminate the session. The PoC Server 112 does not terminate the call unless there is only one participant left.

### 5.7 Extensions to the ISSI/CSSI Protocols

The following describe extensions to the ISSI/CSSI protocols that simplify the Gateway 140 implementation and help reduce the cost of deployment.

5.7.1 Option to Use a Different Audio Codec Instead of an IMBE/AMBE Codec

A different audio codec, such as a G.729, Adaptive Multi-Rate (AMR), OPUS or Codec2 codec, can be used instead of an Improved Multi-Band Excitation (IMBE) or Advanced Multi-Band Excitation (AMBE) codec to reduce the cost of the interoperability solution described herein. This can be done in one of following ways:
Retain the ISSI RTP frame format and substitute IMBE/AMBE blocks with voice blocks encoded using a different codec.
Send voice frames encoded with a different codec in RTP frames and use RTCP for floor control (i.e. ISSI packet type and control blocks).

5.7.2 Setup Static Groups to Avoid the Need for SIP REGISTER Dialogs

Managing a large number of SIP REGISTER dialogs poses scalability and fault tolerance problems. This complexity can be reduced by the following:
Provide a static configuration in the LMR system 142 to set up a group call segments to the PoC system 100, i.e. consider that the Gateway 140 has an implicit registration for a group as a serving RFSS 144.
Accept originating group call segments from the LMR system 142 for PoC groups even when the LMR system 142 has not registered explicitly as a serving RFSS 144 for that group.

### 6 CONCLUSION

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A system for providing communications services in a plurality of wireless networks, the system comprising:
a network-to-network interface (NNI) gateway for inter-communications between a Push-to-Talk-over-Cellular (PoC) system in a first wireless network and a Land Mobile Radio (LMR) system in a second wireless network;
wherein the PoC system provides PoC call sessions for PoC mobile units in the first wireless network;
wherein the LMR system provides Push-to-Talk (PTT) call sessions for LMR subscriber units in the second wireless network; and
wherein the gateway bridges the LMR system to the PoC system such that the PoC system is exposed to the LMR system as an emulated LMR system and the LMR system is exposed to the PoC system as an emulated PoC system when a call is placed across the first wireless network and the second wireless network between the PoC mobile units and the LMR subscriber units.

2. The system of claim 1, wherein the gateway creates and manages identifier mappings to make the PoC mobile units and PoC groups addressable by the LMR system and to make the LMR subscriber units and LMR groups addressable by the PoC system, wherein the PoC groups comprise groups of the PoC mobile units, and wherein the LMR groups comprise groups of the LMR subscriber units.

3. The system of claim 2, wherein the gateway exposes the LMR subscriber units and the LMR groups to the PoC system using mobile unit and group identifiers of the first wireless network.

4. The system of claim 3, wherein each of the LMR subscriber units exposed to the PoC system is assigned a subscriber unit mobile directory number (SU-MDN) chosen from a pool of SU-MDNs reserved for inter-communications between the first wireless network and the second wireless network.

5. The system of claim 3, wherein each of the LMR groups exposed to the PoC system is assigned to a subscriber group mobile directory number (SG-MDN) chosen from a pool of SG-MDNs reserved for inter-communication between the first wireless network and the second wireless network, and wherein the gateway links a respective one of the LMR groups to a PoC group by adding a SG-MDN of the respective one of the LMR groups to the PoC group.

6. The system of claim 2, wherein the gateway exposes the PoC mobile units and the PoC groups to the LMR system using subscriber unit and group identifiers of the second wireless network.

7. The system of claim 6, wherein each of the PoC mobile units exposed to the LMR system is associated with a subscriber unit identifier (SU-ID), and wherein each of the PoC groups exposed to the LMR system is associated with a subscriber group identifier (SG-ID).

8. The system of claim 1, wherein the gateway uses an Inter-RF Sub-System Interface (ISSI) protocol or a Console Sub-System Interface (CSSI) protocol for communications towards the LMR system in the second wireless network, and wherein the gateway uses a PoC NNI protocol for communications towards the PoC system in the first wireless network.

9. The system of claim 8, wherein the PoC NNI protocol is based on a Session Initiation Protocol (SIP) for signaling and a Realtime Transport Protocol (RTP) for media transmission.

10. The system of claim 8, wherein the gateway performs protocol mapping for floor control messages transmitted between the PoC system in the first wireless network and the LMR system in the second wireless network, and wherein:
(a) a PIT Transmit Request transmission is mapped to a Media Burst Control Protocol (MBCP) Request transmission;
(b) a PTT Transmit End transmission is mapped to an MBCP Release transmission;
(c) an MBCP Granted transmission is mapped to a PTT Transmit Grant transmission;
(d) an MBCP Deny transmission is mapped to a PTT Deny transmission; and
(e) an MBCP Taken transmission is mapped to a PTT Start transmission.

11. The system of claim 8 wherein the emulated LMR system belongs to an emulated Wide Area Communication Network (WACN) emulated by the gateway and independent of a WACN of the LMR system in the second wireless network.

12. The system of claim 11, wherein LMR subscriber units homed in the emulated LMR system are considered as being served by the emulated LMR system.

13. The system of claim 11, wherein the gateway sends subscriber group registrations to the LMR system in the second wireless network on behalf of the emulated LMR system in order to receive group calls for groups homed in the LMR system in the second wireless network.

14. The system of claim 11, wherein the gateway receives subscriber group registrations from the LMR system in the second wireless network on behalf of the emulated LMR system for groups belonging to the PoC system in the first wireless network, wherein the subscriber group registrations are used to connect the LMR system in the second wireless network to group calls originated from the PoC system in the first wireless network.

15. The system of claim 11, wherein one or more of the PoC mobile units are associated with one or more LMR subscriber units homed in the emulated LMR system, and wherein the one or more LMR subscriber units homed in the emulated LMR system are treated as visiting the LMR system in the second wireless network and are configured to operate under coverage of the LMR system in the second wireless network.

16. The system of claim 15, wherein the one or more LMR subscriber units homed in the emulated LMR system cause the LMR system in the second wireless network to send subscriber unit and subscriber group registrations to the emulated LMR system, and wherein the emulated LMR system uses the subscriber group registrations received from the LMR system in the second wireless network to connect the LMR subscriber units in the second wireless network to provide unit-to-unit calls, provide subscriber group calls, and complete other service requests originating from the PoC system in the first wireless network.

17. The system of claim 8, wherein the emulated LMR system belongs to a Wide Area Communication Network (WACN) that is not emulated by the gateway, wherein the LMR system also belongs to the WACN, and wherein the gateway connects the emulated LMR system to the LMR system in the second wireless network.

18. The system of claim 17, wherein subscribers served by the emulated LMR system are configured as subscribers belonging to the LMR system in the second wireless network and are considered as visiting the emulated LMR system.

19. The system of claim 18, wherein the emulated LMR system sends subscriber unit and subscriber group registrations to the LMR system in the second wireless network in order to receive unit-to-unit calls, subscriber group calls, and other service requests that originate from the LMR system in the second wireless network.

20. The system of claim 8, wherein a terminating PoC server in the PoC system performs a controlling PoC function for unit-to-unit calls originating from the LMR system in the second wireless network, and wherein an originating PoC server in the PoC system performs a participating PoC function for unit-to-unit calls terminating in the LMR system in the second wireless network.

21. The system of claim 8, wherein a PoC server in the PoC system performs a controlling PoC function for groups hosted in the PoC server irrespective of whether a call originates from the PoC system in the first wireless network or the LMR system in the second wireless network, and wherein the controlling PoC function comprises receiving, by the PoC server in the PoC system, a PTT floor arbitration request from the LMR system in the second wireless network.

22. The system of claim 8, wherein a PoC server in the PoC system performs a participating PoC function for groups hosted in the LMR system in the second wireless network irrespective of whether a call originates from the PoC system in the first wireless network or the LMR system in the second wireless network, and wherein the participating PoC function comprises sending, by the PoC server in the PoC system, a PTT floor arbitration request to the LMR system in the second wireless network.

23. The system of claim 1, wherein the LMR system in the second wireless network is configured to use a first audio codec when communicating in the second wireless network, and wherein the LMR system in the second wireless network is configured to use a second audio codec different from the first audio codec when communicating with the PoC system in the first wireless network.

24. The system of claim 23, wherein the second audio codec is not an Improved Multi-Band Excitation (IMBE) or Advanced Multi-Band Excitation (AMBE) codec, wherein the second audio codec are transmitted in an Inter-RF Sub-System Interface (ISSI) Realtime Transport Protocol (RTP) frame format, and wherein IMBE or AMBE blocks are substituted with voice blocks encoded using the second audio codec when the LMR system in the second wireless network communicates with the PoC system in the first wireless network.

25. The system of claim 23, wherein the LMR system in the second wireless network uses a Realtime Transport Protocol (RTP) frame format other than an inter-RF Sub-System Interface (ISSI)RTP frame format to transmit voice blocks encoded using the second audio codec, and wherein the LMR system in the second wireless network allows for floor control messages of the PTT call session to be transmitted according to a Realtime Transport Control Protocol (RTCP) when the LMR system in the second wireless network communicates with the PoC system in the first wireless network.

26. The system of claim 1, wherein the LMR system in the second wireless network is configured to handle static configuration data to identify subscriber groups that are of interest to the PoC system in the first wireless network, and wherein the LMR system uses the static configuration data to extend a call leg towards the PoC system in the first wireless network during group calls involving the subscriber groups without requiring the PoC system to explicitly send subscriber group registration requests to the LMR system.

27. The system of claim 1, wherein the gateway is configured to perform voice frame re-aggregation to convert first voice frames encoded by the PoC system in the first wireless network to a first format accepted by the LMR system in the second wireless network, and wherein the gateway is configured to perform voice frame re-aggregation to covert second voice frames encoded by the LMR system in the second wireless network to a second format accepted by the PoC system in the first wireless network.

28. The system of claim 1, wherein the gateway is configured to perform transcoding to convert first voice frames encoded in a first audio codec used by the PoC system in the first wireless network to a second audio codec accepted by the LMR system in the second wireless network, and wherein the gateway is configured to perform transcoding to covert second voice frames encoded in the second audio codec used by the LMR system in the second wireless network to the first audio codec accepted by the PoC system in the first wireless network.

29. The system of claim 28, wherein the gateway transmits voice frames encoded using an Improved Multi-Band Excitation (IMBE) or Advanced Multi-Band Excitation (AMBE) codec towards the LMR system in the second wireless network, and wherein the gateway transmits voice frames encoded using an Adaptive Multi-Rate (AMR), OPUS, or Codec2 codec towards the PoC system in the first wireless network.

30. A method for providing communications services in a plurality of wireless networks, the method comprising:
inter-communicating between a Push-to-Talk-over-Cellular (PoC) system in a first wireless network and a Land Mobile Radio (LMR) system in a second wireless network using a network-to-network interface (NNI) gateway;
wherein the PoC system provides PoC call sessions for PoC mobile units in the first wireless network;
wherein the LMR system provides Push-to-Talk (PTT) call sessions for LMR subscriber units in the second wireless network; and
wherein the gateway bridges the LMR system to the PoC system such that the PoC system is exposed to the LMR system as an emulated LMR system and the LMR system is exposed to the PoC system as an emulated PoC system when calls are placed across the first wireless network and second wireless networks between the PoC mobile units and LMR subscriber units.
